(19) United States
(12) Patent Application Publication
(10) Pub. No.: US 2024/0402279 A1
(43) Pub. Date: Dec. 5, 2024

(54) TECHNIQUES FOR FINDING A DEVICE IN MOTION

(71) Applicant: Apple Inc., Cupertino, CA (US)

(72) Inventors: Benjamin A. Werner, San Jose, CA (US); Anup Dhital, San Jose, CA (US); Alexander Singh Alvarado, San Jose, CA (US); Brian G. Kilberg, San Francisco, CA (US); Kenneth M. Pesyna, JR., San Jose, CA (US); Tunc Ertan, Santa Clara, CA (US); Mohamed Youssef, San Diego, CA (US); Ranjini Narayan, San Francisco, CA (US); Shreya Dilip Date, San Diego, CA (US); Jonathan M. Beard, San Jose, CA (US); Lucie A. Huet, Sunnyvale, CA (US); Xiaoyuan Tu, Palo Alto, CA (US); Ryan K. Burns, Santa Clara, CA (US); Ozhan Turgut, Menlo Park, CA (US)

(73) Assignee: Apple Inc., Cupertino, CA (US)

(21) Appl. No.: 18/679,998

(22) Filed: May 31, 2024

Related U.S. Application Data
(60) Provisional application No. 63/470,695, filed on Jun. 2, 2023.

(51) Int. Cl. G01S 5/00; G01S 19/51

(52) U.S. Cl. CPC G01S 5/0027; G01S 19/51

(57) ABSTRACT

A mobile device may determine a set of range values between the first mobile device and the second mobile device based on a difference between the first time and the second time for ranging wireless signals. The mobile device can determine first odometry information using a first sensor on the first mobile device, the first odometry information indicating a first motion of the first mobile device during a time period. The mobile device can receive, via a data channel, second odometry information determined from second measurements captured using a second sensor on the second mobile device. The mobile device can solve an angle between a first reference frame for the first device and a second reference frame for the second device using the set of range values, and the first and second odometry information to display a directional arrow pointing to a current position of the second mobile device.

### CROSS-REFERENCES TO OTHER APPLICATIONS

This application claims priority to U.S. Provisional Application No. 63/470,695, for “TECHNIQUES FOR FINDING A DEVICE IN MOTION” filed on Jun. 2, 2023, which is herein incorporated by reference in its entirety for all purposes.

### BACKGROUND

People can use the navigation features of mobile devices to find other people (e.g., friends, family members, colleagues). Determining the location of a device is a fundamental problem in mobile computing. The importance and promise of location-aware applications has led to the design and implementation of systems for providing location information, particularly in indoor and urban environments where the Global navigation satellite system (GNSS) such as Global Positioning System (GPS) does not work well. For example, GNSS systems may not be enough in crowded locations (e.g., concert venues), indoors, underground, urban areas, or areas of dense foliage. Wireless ranging systems have been developed that may be able to overcome some of the challenges in GNSS systems.

Location systems provide more accurate location information when a mobile device is at rest than when it is in motion. Tracking a moving device is challenging because the inevitable errors that occur in the distance samples used to localize the device are easier to filter out if the device's position itself does not change during the averaging process.

Thus, improvements to determining a position of one mobile device by a second mobile device when one or both of the devices are moving is desired.

### SUMMARY

Various techniques are provided for enabling a user of one device to find a user of another device. In one example, inertial odometry techniques (e.g., visual, an inertial measurement unit (IMU), or both) can be used to locate one mobile device using a second mobile device. Various fusion techniques can also be used to combine information from GNSS-based navigation, ranging information, visual inertial odometry, and pedestrian dead reckoning to improve techniques for locating a device especially during challenging scenarios. The fusion techniques can calculate uncertainty values and select the information with the least uncertainty to generate a pointer in location based applications. Techniques are also disclosed for the efficient transfer of trajectory information between a first mobile device and the second mobile device.

In one general aspect for each of a plurality of ranging sessions occurring during a time period, the techniques may include transmitting a wireless ranging signal at a first time. The techniques may include receiving a wireless response signal from a second mobile device at a second time. The techniques may include determining a range value between the first mobile device and the second mobile device based on a difference between the first time and the second time, thereby determining a set of range values. The techniques may include determining first odometry information from first measurements captured during the time period using a first sensor on the first mobile device, the first odometry information indicating a first motion of the first mobile device during the time period. The techniques may include receiving, via a data channel between the first mobile device and the second mobile device, second odometry information determined from second measurements captured during the time period using a second sensor on the second mobile device, the second odometry information indicating a second motion of the second mobile device during the time period. The techniques may include solving an angle between a first reference frame for the first device and a second reference frame for the second device using the set of range values, the first odometry information, and the second odometry information. The techniques may include displaying, on a display of the first mobile device, a directional arrow pointing from a first current position of the first mobile device to a second current position of the second mobile device. Other embodiments of this aspect include corresponding computer systems, apparatus, and computer programs recorded on one or more computer storage devices, each configured to perform the actions of the methods.

In various embodiments, the second sensor can be an optical sensor and the second sensor information is odometry information. In various embodiments, the first device and the second device are in motion. In various embodiments, the data channel may include a narrow band channel controlled by an ultrawideband processing chip. In various embodiments, the second sensor is an accelerometer, and the second sensor information is acceleration information for the second mobile device. In various embodiments, the solving the angle between the first reference frame for the first device and the second reference frame for the second device is based at least on the range value, the first odometry information and the second sensor information using a least squares equation. In various embodiments, the solving the angle between the first reference frame for the first device and the second reference frame for the second device may include calculating a vertical displacement, a horizontal displacement, and a heading offset between the first mobile device and the second mobile device. In various embodiments, the first odometry information may include visual-inertial odometry information. In various embodiments, the data channel may include a narrow band channel controlled by an ultrawideband processing chip. In various embodiments, the technique can include determining if a relative position between the device does not change. The technique can further include suppressing display of the direction from the first mobile device to the second mobile device based on the angle. Implementations of the described techniques may include hardware, a method or process, or a computer tangible medium.

In one general aspect, techniques may include transmitting a wireless ranging signal at a first time. The techniques may include receiving a wireless response signal from a second mobile device at a second time. The techniques may include determining a first range value between the first mobile device and the second mobile device based on a difference between the first time and the second time. The techniques may include determining a first uncertainty in the first range value. The techniques may include determining a first location of the first mobile device based on first GNSS signals obtained by the first mobile device. The techniques may include receiving, via a data channel between the first mobile device and the second mobile device, a second location of the second mobile device based on second GNSS signals. The techniques may include determining a second range value between the first location and the second location. The techniques may include determining a second uncertainty in the second range value. The techniques may include determining a position vector between the first mobile device and the second mobile device using the first range value, the first uncertainty, the second range value, and the second uncertainty. The techniques may include displaying the pointer based on the position vector. Other embodiments of this aspect include corresponding computer systems, apparatus, and computer programs recorded on one or more computer storage devices, each configured to perform the actions of the methods.

In one general aspect, the techniques may include storing a grid of reference points of a global reference frame. The techniques may include determining, using measurements made by the first mobile device, a first location of the first mobile device within the global reference frame. The techniques may include detecting a wireless signal transmitted from a second mobile device. The techniques may include determining a relative position between the first mobile device and the second mobile device based on the wireless signal. The techniques may include establishing a wireless communications channel with the second mobile device. The techniques may include receiving, from the second mobile device via the wireless communications channel, an offset value corresponding to a distance between the second mobile device and a first reference point of the reference points, where the offset value is measured by the second mobile device. The techniques may include identifying a stored reference point of the grid of reference points corresponds to the first reference point based on the first location of the first mobile device, the relative position between the first mobile device and the second mobile device, and the offset value. The techniques may include determining a second location of the second mobile device based on the stored reference point and the offset value. Other embodiments of this aspect include corresponding computer systems, apparatus, and computer programs recorded on one or more computer storage devices, each configured to perform the actions of the methods.

In various embodiments, the reference points are separated by at least a first threshold distance. In various embodiments, the first threshold distance is less than the offset value. In various embodiments, grid coordinates are less than 5 bytes. The techniques may include determining second grid coordinates for the second device location. The techniques may include determining a direction from the first mobile device too the second mobile device based at least on the location of the first mobile device and the location of the second mobile device in the global coordinate system; and displaying a graphical user interface that indicates the determined direction. The techniques may include determining whether a range between the first mobile device and the second mobile device are less than a predetermined distance. The techniques may include determining an offset between local coordinates of the second mobile device in a local coordinate system and the global coordinate system based a plurality of defined reference points.

In one general aspect, techniques may include determining first inertial odometry information from first inertial measurements captured over a first time period using an inertial sensor on the first mobile device. The techniques may also include identifying a first reference frame corresponding to the first inertial measurements. The techniques may furthermore include determining a first visual odometry information from first visual measurements captured over the first time period using a visual sensor on the first mobile device. The techniques may in addition include identifying a second reference frame corresponding to the first visual measurements. The techniques may moreover include determining a first transformation between the second reference frame and the first reference frame. The techniques may also include determining a displacement of the first mobile device in the first reference frame during the first time period using the first visual odometry information and the transformation. Other embodiments of these techniques include corresponding methods, computer systems, apparatus, and computer programs recorded on one or more computer storage devices, each configured to perform the actions of the techniques.

Implementations of the described techniques may include hardware, a method or process, or a computer tangible medium. Other embodiments are directed to systems, portable consumer devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 illustrates a map of Balboa Park in San Diego, California.

FIG. 2A illustrates a first scenario in which the findee device is either stationary or the movement is confined or bounded withing a defined area.

FIG. 2B illustrates a second scenario in which the findee device is unbounded or moving.

FIG. 3 illustrates an exemplary geometry between the finder device movement and potential findee devices' movement.

FIG. 4 illustrates an exemplary geometry between a finder device and a findee device.

FIG. 5 illustrates exemplary sources of uncertainty for calculating the location of the findee device.

FIG. 6 illustrates a relationship between a trajectory of the finder device and a findee device.

FIG. 7 illustrates an exemplary chart of particle filtering techniques for locating of a mobile device.

FIG. 8 is a flow chart of a process for locating a mobile device, according to an example of the present disclosure.

FIGS. 9A-9B show simplified diagrams of image frames in congested environments according to various embodiments.

FIG. 10 is a simplified diagram showing a transformation between reference frames according to various embodiments.

FIG. 11 is a simplified diagram of an architecture for transforming between reference frames according to various embodiments.

FIG. 12 is a simplified state diagram showing events that trigger determining transformations between reference frames according to various embodiments.

FIG. 13 is a flow chart of a process 1300 for transforming between reference frames, according to an example of the present disclosure.

FIG. 14 illustrates an exemplary scenario in which fusion techniques may be used for locating a mobile device.

FIG. 15 is a flow chart of a process for fusion of location techniques, according to an example of the present disclosure.

FIG. 16 illustrates a priority order for estimating a pointer or an arrow for locating a findee device using a finder device.

FIG. 17 is a flow chart of a process for finding a mobile device using fusion techniques, according to an example of the present disclosure.

FIG. 18 illustrates an exemplary layout for geodetic displacement techniques.

FIG. 19 illustrates a cross-functional flowchart for efficient position transfer between a first mobile device and a second mobile device.

FIG. 20 is a flow chart of a process for efficient transfer of position information, according to an example of the present disclosure.

FIG. 21 shows a sequence diagram for performing a ranging measurement between two mobile devices according to embodiments of the present disclosure.

FIG. 22 shows a sequence diagram of a ranging operation involving a mobile device having three antennas, and according to embodiments of the present disclosure.

FIG. 23 is a block diagram of components of a mobile device operable to perform ranging according to embodiments of the present disclosure.

FIG. 24 is a block diagram of an example device, which may be a mobile device.

### DETAILED DESCRIPTION

Mobile device tracking is a process for identifying the location of a mobile device, whether stationary or moving. Techniques for using one mobile device (finder) to locate a second mobile device (findee) generally assume that the second mobile device is stationary. Mobile device tracking becomes more challenging when both devices are moving.

There are several types of mobile devices that can be used for ranging techniques to estimate the distance or proximity to other devices or objects. These mobile devices can include smartphones, tablets, wearable devices, laptop and notebook computers, Internet of Things (IOT) devices.

Various techniques are provided for enabling a user of one device to find a user of another device. In one example, inertial odometry techniques (e.g., visual, an inertial measurement unit (IMU), or both) and ranging can be used to locate one mobile device using a second mobile device. Various fusion techniques can also be used to combine information from GNSS-based navigation, ranging information, visual inertial odometry, and other motion sensors to improve techniques for locating a device especially during challenging scenarios, e.g., interference and when findee is also moving. The fusion techniques can calculate uncertainty values and select the information with the least uncertainty to generate a pointer in location based applications. Techniques are also disclosed for the efficient transfer of position or trajectory information between a first mobile device and the second mobile device.

I. Challenges with People Finding Techniques

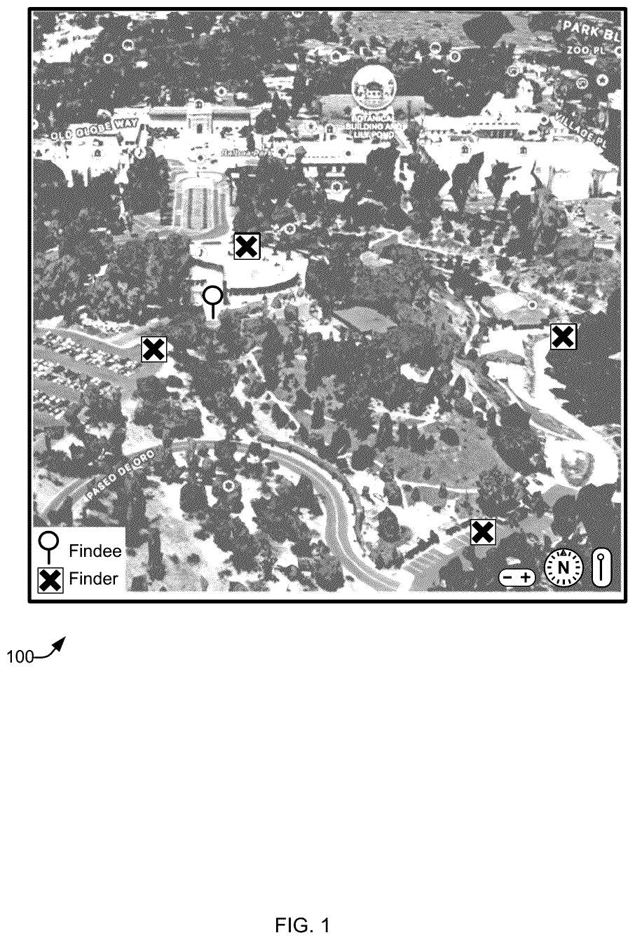

FIG. 1 illustrates a map of Balboa Park in San Diego, California. In the park there may be several finder devices and a single findee device. The finder devices may correspond to children's devices and the findee device can be a parent device. A scenario may exist where the children would be free to explore the area in Balboa Park but would want to be able to locate a parent mobile device. Another example may be school children on a field trip with their teacher. The school children may want to know where the teacher is in the park.

Various techniques can use combination of location measurements (e.g., pedestrian deck reckoning using motion data, ranging measurements such as time-of-flight, and GPS) on the finder's mobile device and/or the findee's mobile device to help the finder device determine a location of the findee mobile device. Some implementations can generate an arrow on a display of the finder device, where the arrow points to the findee. Example techniques using motion data are visual-inertial odometry (VIO) techniques and use of an internal measurement unit (IMU), such as an accelerometer, for determining a relative location of the findee device relative to the finder device.

### A. Use of Stationary Target Techniques

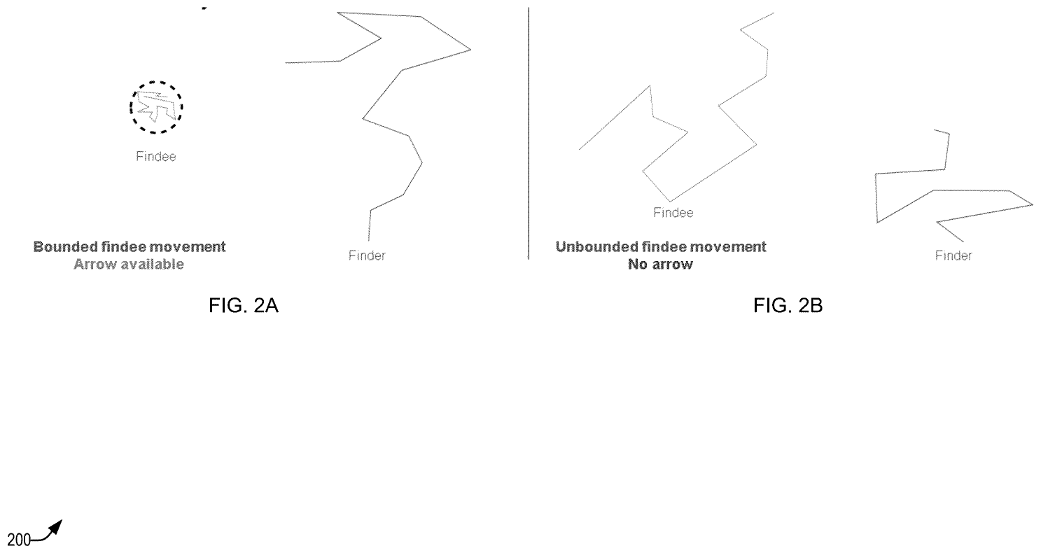

FIG. 2A illustrates a first scenario in which the findee device is either stationary or the movement is confined or bounded withing a defined area. The finder device is unbounded. The finder device can use wireless ranging techniques to determine a distance between the finder device and the findee device. As the finder device can measure motion of the finder device using motion sensors, the changes in ranges resulting from motion of the finder device can be better understood. Therefore, in the first scenario, the finder device will be able to locate the findee device and generate an arrow using ranging techniques even if the finder device is moving.

FIG. 2B illustrates a second scenario in which the findee device and the finder device are both unbounded. In the second scenario, it can be more challenging to resolve the motion of both the finder device and the findee device. While the finder device motion can be measured using motion sensors, it is more challenging for the finder device to understand the motion of the findee device. In this scenario, using previous techniques the finder mobile device would not be able to generate a solution to locate the findee mobile device especially if the findee device moves excessively.

When two mobile devices are moving, several factors can make it difficult to locate one device using another device. The factors can include signal interference, signal strength and range, dynamic environments, time synchronization, and tracking algorithms.

Signal Interference: Moving objects can cause signal interference between the two devices. The movement can create obstacles like walls, buildings, or other objects that obstruct the signal path. This interference can weaken or disrupt the wireless signals, making it challenging for the devices to communicate effectively.

Signal Strength and Range: The signal strength and range of wireless communication technologies like Wi-Fi, Bluetooth, or GPS can vary depending on the distance between the devices and their surroundings. If the devices move too far apart or if the signal strength is weak, it can be difficult for one device to detect or locate the other.

Dynamic Environments: Moving devices often encounter changing environments. For example, if both devices are in vehicles, they may pass through areas with varying signal availability, such as tunnels, areas with poor network coverage, or areas with high electromagnetic interference. These changes can affect the devices' ability to establish a reliable connection and locate each other.

Time Synchronization: For devices to locate each other accurately, they typically rely on precise time synchronization. Moving devices can experience different clock drifts or synchronization issues due to their movement speed or fluctuations in their internal clocks, which can result in inaccuracies during the location tracking process.

Tracking Algorithms: Locating one device using another usually involves complex tracking algorithms that consider factors like signal strength, time delays, and triangulation. When both devices are in motion, these algorithms account for the constant changes in relative positions, velocities, and signal characteristics, which can introduce additional complexities and reduce the accuracy of the tracking process.

Overall, the combination of signal interference, varying signal strength and range, dynamic environments, time synchronization issues, and complex tracking algorithms can make it challenging to locate one mobile device with another when both devices are moving.

### B. Difficult Geometries

If the findee device displacement is known, the motion of the findee device can be accounted for. A potential challenge exists when the geometry between the finder device and the findee does not change. This can occur if the finder device is following at a constant range behind the findee device.

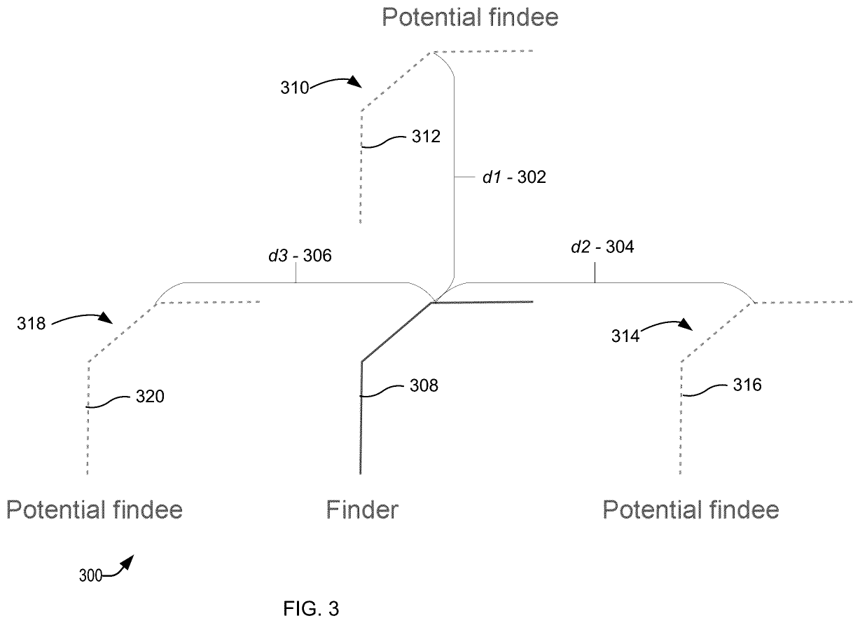

FIG. 3 illustrates an exemplary geometry between the finder device movement and potential findee devices' movement. In FIG. 3, the finder device is moving on a first trajectory 308. The finder device can calculate range information between the finder device and the findee device. If the findee device and the finder device have the same trajectory of motion, the findee device may at three portion locations (a first location 310 with a first trajectory 312, a second location 314 with a second trajectory 316 and a third location 318 with a third trajectory 320). If the range information is constant, we the first range d1 302 can be equal to the second range d2 and equal to the third range d3 306. With this scenario it can be challenging to use the range information to resolve the ambiguity as to which location the findeee device is at because of the symmetry in the problem.

Potentially other sensors, such as visual-odometry sensors, may be able to disambiguate which of the potential trajectories for the findee device is correct.

The finder device may determine that this scenario exists if multiple potential solutions are found for the findee location. If the finder device and findee device are moving in parallel, it is possible that a bearing from the finder device to the findee device may not be calculated.

### II. People Finding Techniques

There are several different techniques for using a first mobile device to find a second mobile device. If the mobile devices have GNSS capabilities (e.g., GPS), one device can use the GNSS position to determine its own location and share that information with the other device. The second device can then use this location information to navigate towards the first device or display it on a map.

Mobile devices can use wireless signals, such as Wi-Fi or Bluetooth, to estimate the distance and direction between them. By measuring the signal strength or using techniques like Received Signal Strength Indication (RSSI), one device can approximate its proximity to the other device.

In various embodiments, communication between the two devices can be established through messaging or calling. If the devices are in contact, one device can request the other to share its location or provide updates on its position.

Mobile devices with Bluetooth capabilities can detect nearby devices using Bluetooth Low Energy (BLE) technology. By scanning for nearby devices or using beacon-like functionality, one device can determine if the other device is in close proximity.

Mobile devices can leverage network-based location services provided by cellular networks. By utilizing network infrastructure and triangulation techniques, the approximate location of a mobile device can be determined.

The availability and accuracy of these techniques may vary depending on factors such as device capabilities, network coverage, signal strength, and user permissions.

A. Determining Arrow Pointing from Finder to Findee

The mobile device can use various positioning techniques to determine a bearing from the finder mobile device to the findee mobile device. Various technologies and techniques can be used to display a location indication (e.g., an arrow) that helps users locate lost or misplaced items and mobile devices. A mobile device can use the location services module of the mobile device to determine its current coordinates. This can be achieved using GPS, Wi-Fi positioning, cellular network data, or a combination of these methods.

A mobile device can calculate the location information of the user's target device (e.g., findee mobile device). This information can be typically associated with the user's identifier and can be accessed through a location services application. By comparing the current location of the user's device with the target device's location, the location application can calculate the relative position or direction between the two devices. This calculation can use information such as the distance, bearing, and orientation between the devices.

The calculated relative position can be represented visually as a pointer or an arrow within the location services application's user interface. The directional information (e.g., a pointer or arrow) can point towards the direction in which the user needs to move to get closer to the target device. The length and size of the directional information (e.g., a pointer or arrow) may vary based on the estimated distance or proximity to the target device.

The directional information (e.g., a pointer or arrow) can be typically displayed on a map or a graphical user interface, providing a visual reference for the user. The location services application may also provide additional information such as the estimated distance, last known location, or other relevant details to assist the user in locating the target device.

The specific implementation of the directional information (e.g., a pointer or arrow) and the underlying technologies may vary based on the device platform, operating system, and the capabilities of the location application. The location services application may incorporate other features such as sound alerts, device pinging, or augmented reality overlays to further aid in device retrieval.

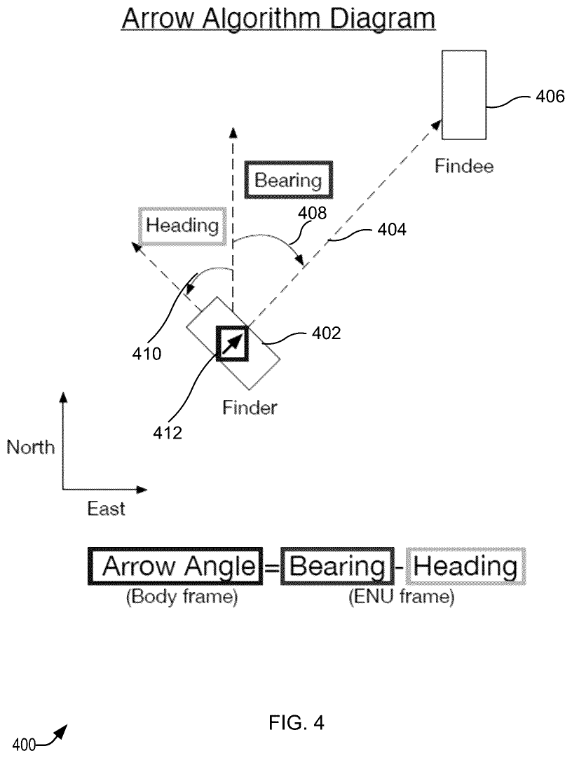

FIG. 4 illustrates an exemplary geometry between a finder device and a findee device. A finder device 402 can use a ranging technique (e.g., time of flight measurement) to measure a range 404 (or distance) between the finder device 402 and the findee device 406. Range 404 information alone does not allow for determining a position of the findee device 406. The finder device 402 can calculate a bearing 408 between the finder device 402 and the findee device 406. In various embodiments the finder device 402 can use multiple antennas to receive wireless signals (e.g., ranging signals) and calculating a time difference of the return signals to determining a bearing 408.

In various embodiments, the finder device 402 can use an mobile compass built into the finder device 402 to determine a heading 410 of the finder device 402. The finder device 402 can determine a relative position to the findee device 406, indicated by an arrow 412, by subtracting the heading 410 of the finder device 402 from the bearing 408 to the findee device 406. The arrow 412 can be displayed on a display of the finder device 402.

### B. Determining Uncertainty

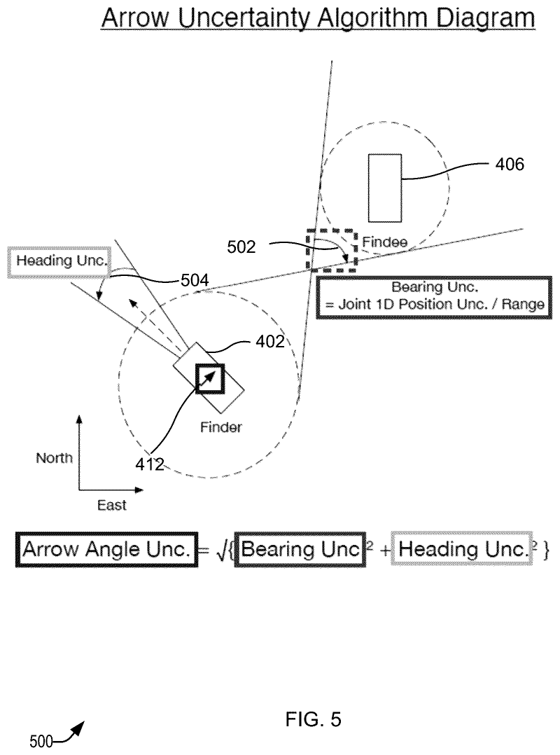

FIG. 5 illustrates exemplary sources of uncertainty for calculating the location of the findee device. The uncertainly in the arrow 412 direction can be a combination of other uncertainties. For example, there may be bearing uncertainty 502. Bearing uncertainty 502 can be dependent on the range value. There can also be heading uncertainty 504. Heading uncertainty 504 can be the result from an imprecise measurement of the heading of the finder device 402 using the mobile compass. Other uncertainty values (e.g., uncertainty in range) can also exist.

The location services application can use the uncertainty values to determine which positioning technique to draw the directional information (e.g., a pointer or arrow). For example, if the uncertainty value for ranging is less than the uncertainty value for GNSS position then ranging techniques can be used to generate the directional information (e.g., a pointer or arrow). In various embodiments, weights can be applied to one or more of the positioning techniques. The weighted positions can be averaged to determine a location for determining the position of the directional information (e.g., a pointer or arrow).

As various measurements (e.g., heading and bearing) are used to calculate the arrow 412, the arrow can also have an uncertainty value. In one example the arrow uncertainty can be calculated using the following formula:

$$Arrow arrow uncertainty = \sqrt{[ {( bearing uncertainty )}^{2} + {( heading undertainty )}^{2} ]}$$

### III. Combined Ranging and Visual/Inertial Odometry Techniques

Mobile devices have various capabilities to locate other mobile devices. For example, GNSS-based techniques, ranging techniques, visual-inertial techniques, RSSI techniques, and dead reckoning techniques can all be used to determine a location of the first mobile device and a second mobile device. Ranging techniques can be combined with visual odometry techniques to determine a location of a second mobile device by solving for an angle between the first reference frame and the second reference frame by bounding the reference plane by the range values determined by ranging.

### A. Visual/Inertial Odometry Techniques

Visual-Inertial Odometry (VIO) is a sensor fusion technique used to estimate the pose (position and orientation) of a moving camera or an object in a 3D environment by combining visual information from a camera with inertial measurements from an inertial measurement unit (IMU).

Visual-Inertial Odometry techniques can leverage the complementary strengths of visual information and inertial measurements of a mobile device (e.g., a mobile device) to overcome the limitations of each sensor individually. Visual data can provide rich and detailed information about the environment, allowing for precise feature tracking and mapping. On the other hand, the IMU can provide high-frequency motion measurements that can be robust to lighting conditions. IMU measurements can be used to estimate the camera's acceleration, angular velocity, and orientation.

The VIO system can extract distinctive visual features from the camera images, such as corners, edges, or other salient points. These features serve as reference points for tracking and mapping.

The VIO techniques can track the extracted features across consecutive frames by matching them based on their appearance and motion. This process can involve estimating the correspondences between the features in different frames. This process can use optical flow or feature descriptors techniques for tracking. The features are generally considered to be static and part of the environment. After matching them, the displacement of those features is calculated jointly with the camera displacement.

Simultaneously, the IMU can provide continuous measurements of the camera's linear acceleration and angular velocity. These measurements can be integrated over time to estimate the camera's velocity and position using numerical integration techniques. The techniques can include but are not limited to the trapezoidal rule or higher-order integration methods. Inertial sensors can serve as a constraint for camera movement between frames.

The tracked visual features and the estimated motion from the IMU can be combined through sensor fusion techniques, such as an Extended Kalman Filter (EKF) or a nonlinear optimization approach. The fusion algorithm can align the visual measurements with the inertial measurements by minimizing the error between predicted feature positions and their actual locations.

The fused information can be used to estimate the camera's pose (position and orientation) relative to an initial reference frame or a known map. The pose estimation can be achieved by updating the state of the VIO system using the sensor fusion algorithm.

As the mobile device and camera move, the VIO system can simultaneously build a map of the environment and localize itself within that map. The tracked features and estimated camera pose can be used to create a visual map. The visual map can be further refined using techniques like bundle adjustment or loop closure detection.

By combining the visual information from the camera with the inertial measurements from the IMU, VIO can provide robust and accurate estimates of the camera and thus mobile device's motion, even in challenging conditions where only one sensor may not be sufficient. The integration of visual and inertial data enhances the system's ability to track objects, estimate their trajectory, and navigate in complex environments.

In various embodiments, only the finder device (and not the findee device) has visual inertial odometry capabilities. In various embodiments, the findee device may only have inertial capabilities.

Radiofrequency (RF) measurements can be widely employed for indoor positioning since many RF systems are already deployed and are part of the communication infrastructure. RF wireless technologies used for positioning include WLAN or Wi-Fi, RFID, UWB, Bluetooth, ZigBee, and LTE. UWB is a high-bandwidth communication technology with multipath robustness and good material penetrability that can achieve centimeter-level accuracy for 3D indoor positioning. However, performance can be degraded under strong scattering conditions. UWB systems usually utilize time-based measurements such as time of arrival (ToA) or TDoA for position estimation.

B. Both Findee and Finder have Inertial Odometry

In various embodiments, the both the finder device can findee device can employ ranging techniques and inertial displacement (visual or otherwise) to determine location of the findee device relative to the finder device. The ranging techniques (e.g., time-of-flight ranging) can provide possible trajectories, but more than one relative trajectory may be possible. The odometry information allows for solving for the angle to put both distances and trajectories into the same reference frame, so the position of the findee can be accurately identified. A least squares equation, as described below, can be used to calculate the position of the findee device.

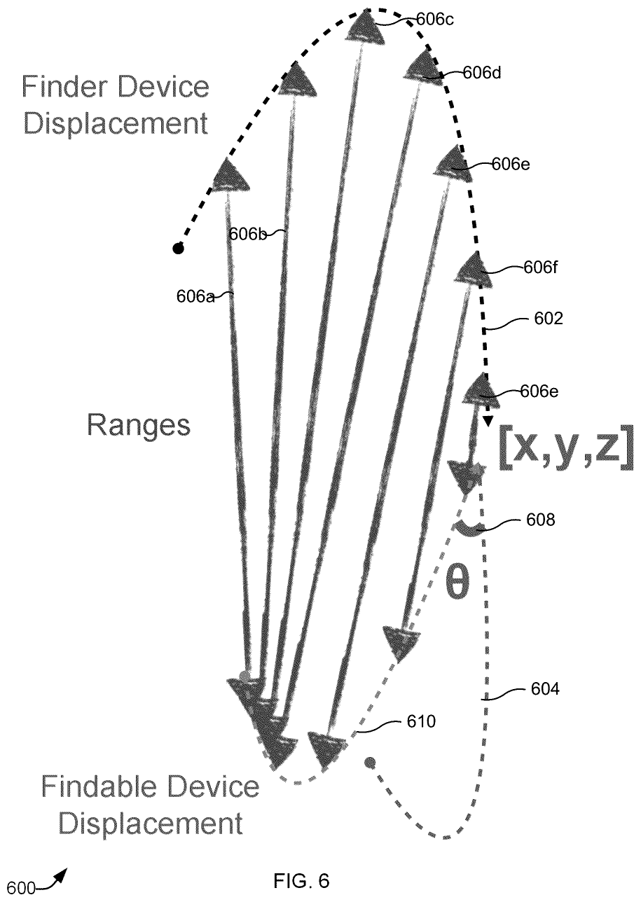

FIG. 6 illustrates a relationship between a trajectory of the finder device and a findee device. Each of the finder device and findee device can operate in a different coordinate system. A finder device can travel along a first trajectory 602. The first trajectory 602 can be determined using VIO techniques on the finder device. The VIO techniques can yield a second trajectory 604 for the findee device. At least initially, the second trajectory 604 can be in an arbitrary coordinate frame. The finder device can determine range 606 (shown as a series of range measurements 606a-606e). However, other potential curves can be possible, such as the third trajectory 608 may be possible.

At various points in time, the finder device can determine a range value between the two devices. Based on the range values and VIO information, the finder device can link up these two coordinate systems (e.g., for the finder device and findee device). The finder device can solve for the initial offset of the findee device and then also noting that these two frames are actually already gravity aligned. The z-axis between the two coordinate systems should be approximately the same because gravity is strong and both coordinate systems understand gravity pretty well. The gravity value could be at different altitudes but the finder device may able to detect what that difference is just with using some gravity sensor. Alternatively, the finder device can assume that the finder device and findee device are about the same in altitude.

The finder device can actually solve for the difference between the two coordinate systems in terms of all three directions (x, y, z). The first mobile device can solve for not only where the two coordinate systems are with respect to each other in a horizontal frame, but also how far apart the two coordinate systems are in terms of the vertical. This can be described as a joint estimation problem where the mobile device is solving for x, y, z, meaning that displacement and then the angle theta (θ). Angle theta (θ) can be an arbitrary orientation of the two coordinate frames with respect to each other. Angle theta (θ) can be calculated in terms of pitch, roll, and yaw of the mobile device or a rotation around gravity. VIO just establishes a coordinate system arbitrarily based on the way the original device was facing when it started. The mobile devices can be facing different ways when visual-inertial odometry techniques are started so can be kind an arbitrary angle that the finder device can solve for.

Therefore, the finder device only need solve for an additional single horizontal angle between the coordinate systems in order to understand where the finder device is with respect to the findee device.

A data channel can be established between the finder mobile device and the findee mobile device. The data channel can be used to send information (e.g., visual odometry information) from the findee device to the finder mobile device. In various embodiments, a wireless chip (e.g., UWB chip) can provide such a data channel.

In various embodiments, the findee device can send an applicability timestamp and then an estimated a 3D position of the second mobile device in its own coordinate system that it established. The finder device may not necessarily know what that other coordinate system is but the finder device can determine what the change in the ranging over time from the other device. Therefore, the finder device can determine the displacement between the devices. The finder device can establish an estimated position by projected change in position. In particular, the finder device can determine a vector from the findee device to the finder device, so the finder device can calculate where the second mobile device should be.

As shown in FIG. 6, the ranges values 606 between the first mobile device and the second mobile device do not fit the second trajectory 604 for the findee device. However, if the second trajectory 604 is rotated by an angle θ 608, then the range values 606 would appear to fit the third trajectory 610. In order to figure out where exactly the findee device is in the finder's coordinate frame, the first mobile device can solve for x, y, z. The first mobile device can also solve for the angle θ 608, which is the rotation around that horizontal angle. Essentially this is a problem where there is a finder device trajectory and a findee device trajectory that we are trying to put relative to the finder device. The range values can establish constraints on where that findee trajectory can exist. This can be a joint problem in which the x, y, z origin the angle θ 608 can be solved together. A methodology that can be used to solve this problem is nonlinear least squares to do that solving. This can be essentially optimizing for getting the minimum error on the ranges while also changing angle θ 608 and x, y, z.

In various embodiments, the VIO techniques may use six to eight measurements so that the values are accurate enough to be able to do the least squares to then line up those points. After that point, when the finder device determines new values, the technique can fine-tune the position and be accurate. The initial estimation of trajectory is the most difficult.

In various embodiments, the finder device can simulate different trajectories of where the findee device can be in time (e.g., while walking). Each of the different trajectories can be weighted based on a likelihood that is the actual position of the findee device. The finder device can generate an directional information (e.g., a pointer or arrow) based on a mean estate of the projected positions.

The following formula can be used to solve for the position of the second device:
“\*MERGEFORMAT \*MERGEFORMAT

$$Y = ( {y}_{i} , {p}_{i}^{s} , {q}_{i} )$$

$$X = arg {min}_{x} \sum {r}_{i}^{2}$$

$${r}_{i} = {y}_{i} - ‖ {q}_{i}^{s} - {p}_{i}^{s} ‖$$

$${q}_{i}^{s} = {R}_{t}^{s} + {q}_{i}^{t} + O$$

$${R}_{t}^{s} = [ \begin{matrix}cos δ & sin δ & O \\ sin δ & cos δ & O \\ O & O & 1\end{matrix} ]$$

$$x = [ \begin{matrix}{O}_{x} \\ {O}_{y} Θ \\ {O}_{z}\end{matrix} ]$$

where Y is a set of all large, measured pairs with VIO displacement measurement; O is unknown offset between coordinates; yᵢ is range between self and target, measured with wireless signal (e.g., UWB); pᵢ is the self-position in self-coordinate frame, VIO measured; qᵢ is the target position in target coordinate frame, VIO measured. Solve using non-linear Gauss/Newton iteration. Where \hat{x} is initial guess based on measurements:

$$r = y - f ( \hat{x} )$$

$$f ( x ) = ‖ {q}^{s} - {p}^{s} ‖$$

$$H = \frac{\partial }{\partial x} f ( \hat{x} )$$

$${\hat{x}}^{t} = \hat{x} + \frac{{H}^{T} r}{( {H}^{T} H )}$$

At a specific time from Arrow (φₖ) and distance (dₖ) to show to user based on \hat{x}

$${d}_{t} = ‖ {q}_{k}^{s} - {p}_{k}^{s} ‖$$

$${q}^{b} = {R}_{s}^{b} ( {q}_{k}^{s} - {p}_{k}^{s} )$$

$${q}_{k}^{s} = {R}_{t}^{s} + {q}_{k}^{t} + 0$$

$${φ}_{k} = atan 2 ( {q}_{0}^{b} , {q}_{1}^{b} )$$

Rₛ^{b} is rotation matrix from self coordinate system to cwrsent self device body coordinate system

Using these techniques, several initial guesses can made based on the minimum range seen between findee and finder at a given time. The techniques can try each of three orthogonal directions for offsets 0, and 60 degree increments for theta. Each guess is iterated on using the Gauss-Newton method. A stopping criteria can be determined and reached (e.g., either step size is very small, or a maximum number of iteration is reached). The final \hat{x} of derived from each guess is weighted based on how well the minimization of the residuals r² worked. Final \hat{x} values can be ignored when they are not similar to others. When one meets a threshold for being the significantly best minimization, an arrow may be yielded. Otherwise, if there exists two or more \hat{x} that are different enough, and similarly likely, the techniques will not likely show an arrow.

### C. Only Finder has Inertial Odometry

In various embodiments, only the finder device has inertial odometry. In this case other techniques can be used to determine a location of the findee device. In some cases, a particle filter can be used to estimate location.

A particle filter is a probabilistic estimation technique that can be used in conjunction with visual-inertial odometry (VIO) to track objects or estimate their pose. A particle filter technique can be particularly useful in situations where the system's state cannot be accurately represented by a single Gaussian distribution and where non-linear or non-Gaussian uncertainties are present. In the context of VIO, particle filter techniques can work as follows:

The particle filter can begin by initializing a set of particles, where each particle represents a possible state hypothesis of the object's (e.g., the findee device) pose (position and orientation). These particles can be sampled from a prior distribution, typically based on an initial estimate or prior knowledge of the system.

Each particle's pose can be propagated forward in time using a motion model, which incorporates the inertial measurements from the IMU. The motion model predicts the new pose of each particle based on the previous pose and the estimated motion derived from the IMU data. This step accounts for the expected motion of the object.

The visual information from the camera from the finder device can be used to update the particle weights. The VIO system can match the observed visual features with the predicted features based on each particle's pose hypothesis. The matching can be performed using techniques like feature tracking or feature descriptors. The particle weights can be calculated based on the similarity between the observed and predicted features. Particles that better align with the visual observations can be assigned higher weights.

In the resampling step, particles can be selected from the current set of particles with a probability proportional to their weights. Particles with higher weights have a higher chance of being selected multiple times, while particles with lower weights may not be selected at all. This process leads to a new set of particles that represents a more accurate approximation of the posterior distribution.

The estimated object pose can be calculated based on the resampled particles. This can be done by computing the weighted average or the most probable pose among the resampled particles. The resulting pose estimation represents the system's best estimate of the object's current state.

These steps can be repeated as new measurements become available. The particle filter continually updates and refines the object's pose estimation based on the fusion of visual and inertial data.

An advantage of a particle filter is its ability to represent and track a wide range of uncertainties and handle non-linear and non-Gaussian distributions. The particles in the filter allow for a diverse representation of possible object poses and enable the system to explore different hypotheses. Through iterative updates, the filter converges toward a more accurate estimate of the object's pose based on the observations from both the visual and inertial sensors.

By integrating a particle filter with visual-inertial odometry, it is possible to achieve robust tracking and pose estimation of objects, even in challenging scenarios where uncertainties and non-linearities are present.

A particle filter can be used to take advantage of the fact that the ranging (e.g., TOF) data generally only has a positive bias. Particle filters are applications of Monte Carlo methods to Bayesian estimation. The measured distance is rarely shorter but can be longer due to multi-path or interference from the body. The IMU provides the correct shape of the findee trajectory but not the right scale. The particles are randomly generated from the motion (or dynamics) model. Sampling from the dynamics can be a very diffuse distribution. Thus, the proportion of particles that sample a trajectory close to the measurements may be very small. Therefore, a large number of particles may be required to represent the high-probability regions of the state space. Resampling is a strategy to improve the number of particles following trajectories with high likelihood. At each time step, copies of highly likely particles replace unlikely particles via a random sampling process. Some of the resampling strategies include multinomial resampling, stratified resampling, systematic resampling, and residual resampling

The particle filter can simulate the different trajectories that the findee could be moving based on motion data (e.g., the IMU data) and the ranging data (e.g., TOF data). Each trajectory can be weighted. An arrow can be generated based on a mean estimate of where the trajectories end. The different paths can be different scales, e.g., 70-150% of what the motion from (e.g., IMU) is providing. There can be thousands of particles (possible trajectories) that are being simulated along with a possible scale. Each particle can have random variations and a likelihood of the given position is determined based on TOF and finder trajectory. The 5 variables of a particle are x, y, z, θ, and scale. If particles have a low likelihood, they can be removed, and other random fluctuations of higher likelihood particles can be used. A data channel is used to get any odometry information from the findee, when available.

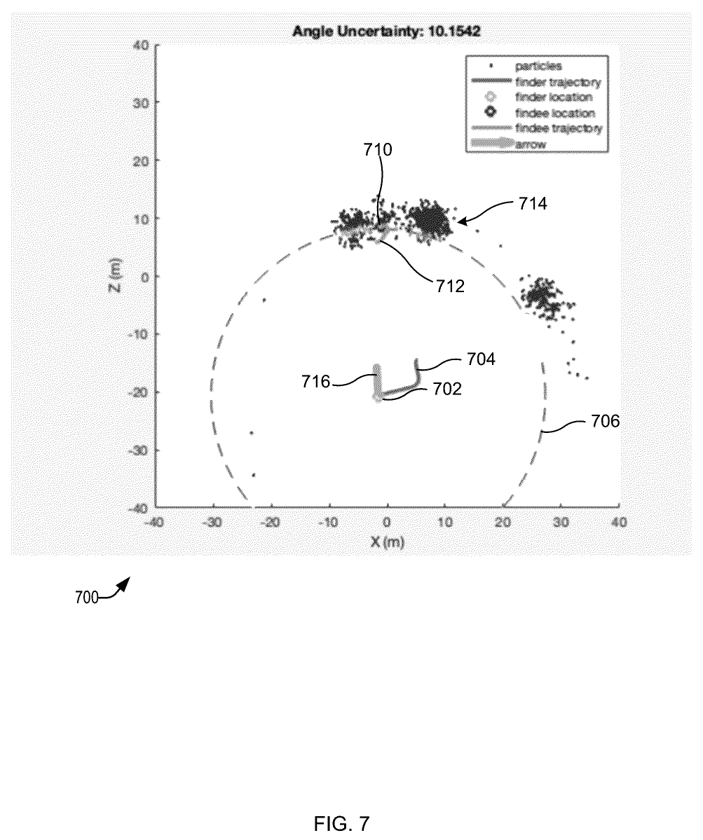

FIG. 7 illustrates an exemplary chart 700 of particle filtering techniques for locating of an object 710. The exemplary chart is plotted as z-location (in meters) versus x-location (in meters)—although other coordinates and measured values can be used. A present finder location 702 is illustrated along with the finder trajectory 702. As ranging techniques can be used to find the object 710, a range circle 706 is illustrated showing the range to the object 710. The object 710 should be located on the range circle 702. As the object 710 is also moving, an object trajectory 712 is also illustrated. FIG. 7 illustrates particles 714 that represents a possible state hypothesis of the object's (e.g., the findee device) pose (position and orientation). The finder device can use the range circle 706 and the particle 714 to calculate a likely position of the object 710. The finder device can generate an arrow 716 that points in the direction of the object 710.

### D. Flow Chart

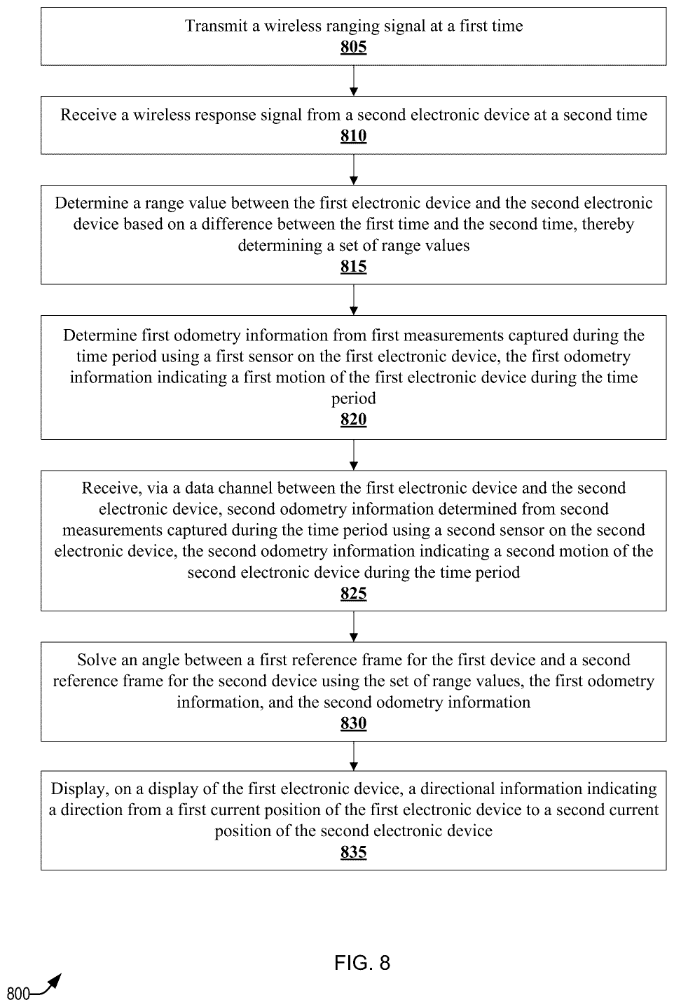

FIG. 8 is a flow chart of a process 800 for locating a mobile device, according to an example of the present disclosure. According to an example, one or more process blocks of FIG. 8 may be performed by a mobile device.

At block 805, process 800 may include transmitting a wireless ranging signal at a first time. The wireless signal can be any of a number of wireless protocols such as but not limited to ultrawide band (UWB), Bluetooth (BT), Bluetooth Low Energy (BLE), Wi-Fi, Zigbee, etc. For example, the mobile device may transmit a wireless ranging signal at a first time, as described above.

At block 810, process 800 may include receiving a wireless response signal from a second mobile device at a second time. The wireless response signal can be received by one or more antenna on the mobile device. The wireless response signal can be the same wireless protocol and the wireless ranging signal. For example, device may receive a wireless response signal from a second mobile device at a second time, as described above.

At block 815, process 800 may include determining a range value between the first mobile device and the second mobile device based on a difference between the first time and the second time, thereby determining a set of range values. The wireless signal can travel at the speed of light (c). If the first mobile device (e.g., finder device) knows the transmitting time of the wireless ranging signal, the reception time of the wireless response, and a processing time for the second mobile device (e.g., the findee device), the first mobile device can calculate a range value by multiplying the time delay (e.g., reception time minus transmission time minus processing delay) by speed of light (c). For example, first mobile device may determine a range value between the first mobile device and the second mobile device based on a difference between the first time and the second time, thereby determining a set of range values, as described above.

In various embodiments, blocks 805, 810, and 810 can be performed for each of a plurality of ranging sessions occurring during a time period.

At block 820, process 800 may include determining first odometry information from first measurements captured during the time period using a first sensor on the first mobile device, the first odometry information indicating a first motion of the first mobile device during the time period. In various embodiments, the first odometry information can include visual inertial odometry information. In various embodiments, the first odometry information can be received from one or more of a camera and a motion sensor. The motion sensor can be an IMU. For example, the first mobile device may determine first odometry information from first measurements captured during the time period using a first sensor on the first mobile device, the first odometry information indicating a first motion of the first mobile device during the time period, as described above.

At block 825, process 800 may include receiving, via a data channel between the first mobile device and the second mobile device, second odometry information determined from second measurements captured during the time period using a second sensor on the second mobile device, the second odometry information indicating a second motion of the second mobile device during the time period. For example, the second mobile device may determine second odometry information from second measurements captured during the time period using a second sensor on the second mobile device, the second odometry information indicating a second motion of the second mobile device during the time period, as described above.

In various embodiments, the second sensor is an optical sensor, and the second sensor information is odometry information.

In various embodiments, the data channel can be generated via the wireless signal chip. In various embodiments, the data channel may include a narrow band channel controlled by an ultrawideband processing chip.

For example, device may receive, via a data channel between the first mobile device and the second mobile device, second odometry information determined from second measurements captured during the time period using a second sensor on the second mobile device, the second odometry information indicating a second motion of the second mobile device during the time period, as described above.

At block 830, process 800 may include solving an angle between a first reference frame for the first device and a second reference frame for the second device using the set of range values, the first odometry information, and the second odometry information. In various embodiments, the angle between the first reference frame for the first device and the second reference frame for the second device can be solved using a least squares formula as described above. For example, device may solve an angle between a first reference frame for the first device and a second reference frame for the second device using the set of range values, the first odometry information, and the second odometry information, as described above.

In various embodiments, the solving the angle between the first reference frame for the first device and the second reference frame for the second device is based at least on the range value, the first odometry information and the second sensor information using a least squares equation.

In various embodiments, the solving the angle between the first reference frame for the first device and the second reference frame for the second device may include calculating a vertical displacement, a horizontal displacement, and a heading offset between the first mobile device and the second mobile device.

In various embodiments, the first device and the second device are in motion.

In various embodiments, the second sensor is an accelerometer, and the second sensor information is acceleration information for the second mobile device.

At block 835, process 800 may include displaying, on a display of the first mobile device, directional information indicating a direction from a first current position of the first mobile device to a second current position of the second mobile device. For example, device may display, on a display of the first mobile device, a directional arrow pointing from a first current position of the first mobile device to a second current position of the second mobile device, as described above. In various embodiments, the directional information can be an arrow.

Process 800 may include additional implementations, such as any single implementation or any combination of implementations described below and/or in connection with one or more other processes described elsewhere herein.

In an aspect, a mobile device can include one or more processors, a memory coupled to the one or more processors, the memory storing instructions that cause the one or more processors to perform any one or more of the operations described above.

In an aspect, a non-transitory readable medium can store a plurality of instructions that when executed by one or more processors of a mobile device cause the mobile device to perform any of the operations described above.

In various embodiments, process 800 further includes determining if a relative position between the device does not change; and suppressing display of the direction from the first mobile device to the second mobile device based on the angle.

It should be noted that while FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

### IV. Shared Reference Frame for Switching Between Odometry Techniques

Visual odometry may fail in some situations. For example, a device may fail to detect movement when the device is moving with a crowd of people. Visual odometry (e.g., visual inertial odometry) detects movement by measuring changes to identify features in sequential images. However, visual odometry may fail when a device identifies features on individuals moving with the device. The device may detect movement in the images, but the device may fail to detect displacement across images because the tracked features keep pace with the device. Alternatively, the device may fail to detect displacement because a large amount of movement means that there are not a sufficient number of static features that can be compared across image frames. While the device may detect a large amount of movement across image frames, the device does not have sufficient information to determine a correspondence between sequential frames.

Inertial odometry can be used to determine a device's movement when visual odometry (e.g., visual inertial odometry) is unreliable (e.g., fails). Inertial odometry techniques may be accurate over short distances, but such techniques can be less accurate than visual odometry in some circumstances. To compensate for the inertial odometry errors, the mobile device may compare the inertial and visual odometry results to determine an error value for the inertial odometry values. When the mobile device determines that the visual odometry results are unreliable, the device can use the inertial odometry values, and the current error value, to determine the mobile device's movement until reliable visual odometry values are available.

### A. Visual Odometry Errors in a Congested Environment

Congested environments can cause visual inertial odometry (VIO) techniques to produce unreliable results (e.g., fail). VIO techniques measure a device's movement by comparing the apparent movement (e.g., parallax) of features across sequential images captured by the device's camera. Accordingly, VIO techniques may only be able to determine a device's movement where at least one feature is present in multiple images, and where the at least one feature changes positions between the images. However, such features may be difficult to identify in a congested environment.

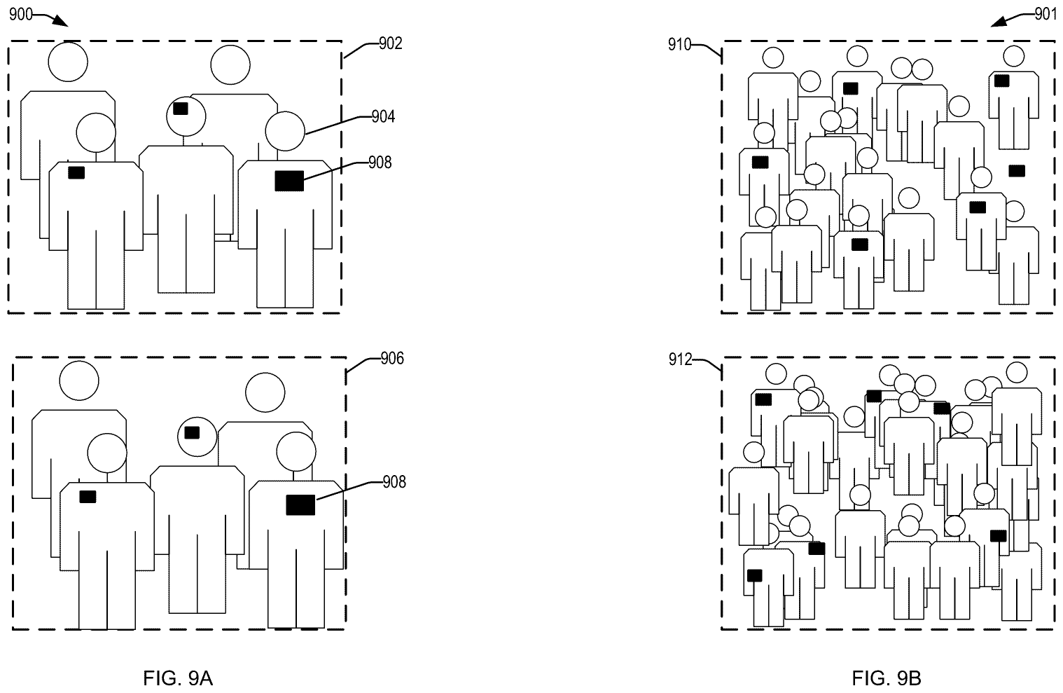

FIGS. 9A-9B show simplified diagrams 900-901 of image frames in congested environments according to various embodiments. FIG. 9A shows a first scenario where a congested environment can cause VIO techniques to produce unreliable results. Image frame 902 shows a first image frame captured by a device (e.g., a computing device, a mobile device, etc.) performing VIO techniques during the first scenario. In the first scenario, the device is performing VIO techniques while moving in a congested environment where other objects/individuals move along with the device. For example, the device may be held or worn by an individual who is in a crowd that is leaving a stadium after a sports game. The device identifies features, shown as black boxes, on individual(s) 904 that are walking in front of the device. Features can be patterns of pixels that can be individually identified (e.g., an instance of a feature can be recognized as that specific instance across images), and features can include edges, corners, blobs, ridges, etc.

Image frame 906 shows a second image frame captured by the device performing VIO techniques during the first scenario. The device may have moved significantly between image frame 902 and image frame 906, however, the device is moving along with the crowd and the movement may not be apparent. The VIO techniques performed by the device recognize features on the individual(s) 904 that comprise the crowd. However, because the crowd is moving with the device, the features appear static. For example, feature 908 is in approximately the same position between image frame 902 and image frame 906. Accordingly, the VIO techniques do not detect that the device has moved because the features do not show any apparent movement across the image frames. The VIO techniques may not detect movement if none of the features appear to move or if a threshold number of features appear to move. A feature may appear to move if a difference in the position of the feature between frames exceed a threshold.

Turning now to FIG. 9B, shows a second scenario where a congested environment can cause VIO techniques to produce unreliable results. In the second scenario, there is sufficient movement in the congested environment so that the device cannot identify features between image frame 910 and image frame 912. The features are shown as filled black boxes, and the second scenario may be a crowded metro station where a large crowd of individuals are moving in different directions. However, the second scenario can be any environment with a large amount of movement (e.g., a busy roundabout with a large number of vehicles).

As shown in FIG. 9B, the VIO techniques may fail to identify features that are present in both image frame 910 and image frame 912. This failure to identify a threshold number of features in both image frames may be due to the crowd's movement. For example, a physical object may be identified as a feature in frame 910, and the movement of the crowd between frames may hide the object in frame 912. In another example, a feature can correspond to a pattern on a first individual's shirt and the movement of the crowd may mean that a second individual has blocked the pattern from the camera's view.

In addition or alternatively, the movement of the crowd may mean that a feature is identified on an individual or object that leaves the camera's view between image frames. For example, a feature that was identified on a car at a busy intersection in a first frame may leave the intersection before a second frame is captured. Accordingly, VIO techniques may not be capable of detecting the device's movement between image frame 910 and image frame 912, because there are not sufficient features that can be compared across image frames to determine the device's movement relative to those features. The number of features can be sufficient if the number of features present in both image frames exceeds a threshold. The threshold for either the first or second scenario can be 1 feature, 2 features, 3 features, 4 features, 5 features, 10 features, 15 features, 20 features, 25 features, 50 features, or 100 features.

### B. Reference Frames

A device's displacement in a physical environment can be determined using either inertial odometry (IO) or visual inertial odometry (VIO) techniques. The displacement can be represented as a series of poses (position and orientation) over a time period or a continuous displacement over a time period. A device may switch between odometry techniques in scenarios where the displacement estimated by one odometry technique becomes unreliable. However, each of the odometry techniques may represent a pose or displacement within separate reference frames, and switching between odometry techniques may mean switching between reference frames.

A reference frame can be a mapping of a coordinate system to a physical environment. For example, the coordinates assigned to a pose in a VIO reference frame may be determined relative to axes that are determined based on the camera's pose during initialization, but the coordinate system of an IO reference frame may include coordinates that are determined with respect to axes that correspond to gravity and magnetic north. Because of these different reference frames, the same physical position may be represented by different coordinates depending on whether the pose was determined by VIO or IO techniques. Accordingly, switching between odometry techniques can require transforming some or all of the coordinates representing different poses to a common reference frame so that a displacement between poses can be determined.

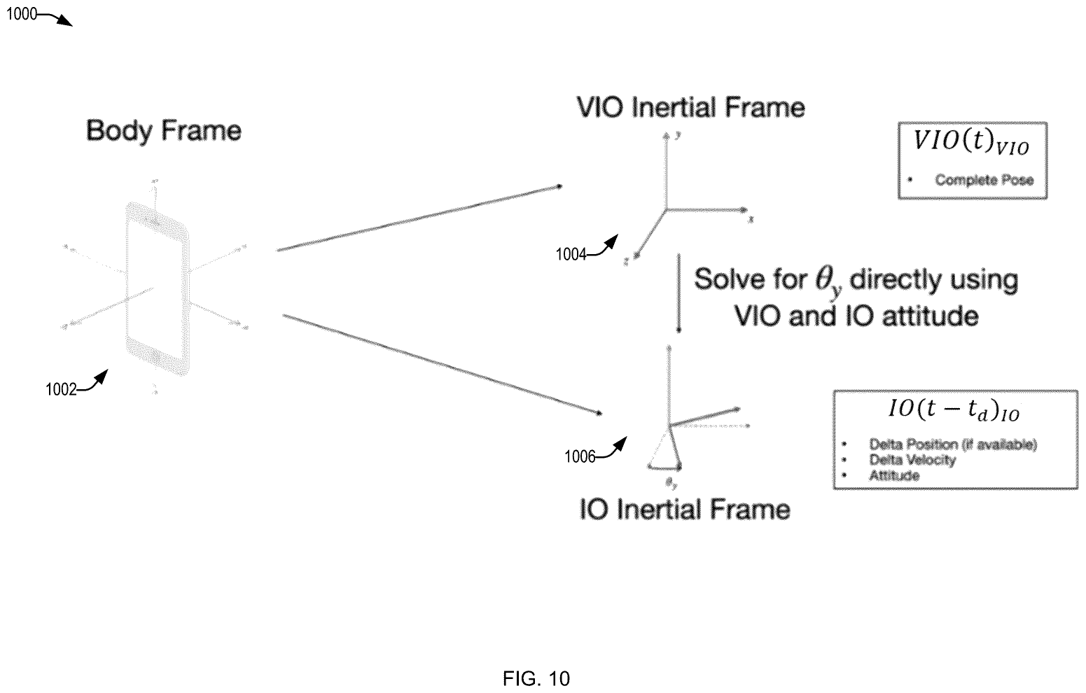

FIG. 10 is a simplified diagram 1000 showing a transformation between reference frames according to various techniques. The body frame 1002 can be a reference frame relative to a tracked mobile device's physical features. For example, the body frame 1002 can include orthogonal axes through each of the mobile device's exterior surfaces. A human may understand the device's pose in body frame 1002 (e.g., screen side up), however, the odometry techniques may not represent the device's displacement directly in the body frame 1002.

Each odometry technique can assign coordinates to the mobile device's pose within separate reference frames. The separate reference frames may have a fixed relationship with regard to the body frame 1002 and each other, and transformations between the body frame and each of the VIO frame 1004 and the IO frame 1006 can be known. However, the transformation between the VIO frame 1004 and the IO frame 1006 may not be known. The mobile device may determine its displacement by comparing different poses for the device, and there may be no need to transform between reference frames as long as the poses are all within the same reference frame. For example, the mobile device's position may initially be tracked in VIO frame 1004, and the device's displacement can be determined by comparing coordinates representing poses within this reference frame. For VIO frame 1004, the change in the mobile device's displacement with respect to time (t) can be represented with the following notation: VIO(t)_{VIO} Continuing the example, the mobile device may change from tracking displacement using VIO techniques to tracking displacement using IO techniques. The mobile device may make this change because the VIO poses have become unreliable. To begin tracking the mobile device's position using IO techniques, the mobile device may need to determine a correspondence between the VIO poses (e.g., the coordinates representing a physical position and orientation in the VIO frame 1004) and subsequent IO poses (e.g., the coordinates representing a physical position and orientation in an IO frame 1006). Without this correspondence, the mobile device may not be able to determine the displacement between a VIO pose and a subsequent IO pose because the orientation, origin, and scale can be different in each reference frame. This correspondence can be used to determine a transformation that can be used to switch poses between reference frames.

A transformation can be a function that uses a correspondence between reference frames to convert coordinates from a first reference frame into coordinates in a second coordinate system. In a simplified analogy, a transformation can be used to switch between imperial and metric units. For example, an American visitor to Edinburgh Scotland wants to check the local weather, but the Scottish news reports temperatures in Celsius (metric) and the American is only familiar with Fahrenheit (imperial). In this case, the units in each system have a different scale (e.g., a degree in Fahrenheit is 5/9 of a degree in Celsius), a different origin (e.g., 0 degrees Celsius is the freezing temperature of water and 0 degrees fahrenheit is below freezing), but the orientation is the same (e.g., both systems increase as temperature increases). This correspondence can be used to determine the following transformation between the two systems:

$$y ° F . = ( x ° C . \frac{9}{5 ° C .} + 32 ) ° F .$$

Where x is the temperature in Celsius, y is the temperature in Fahrenheit, 9/5 is the correspondence between the scales for each system, and 32 is the correspondence between origins for each system. The American visitor can use this transformation to determine that 20 degrees Celsius is 68 degrees fahrenheit. This simplified example concerns a one-dimensional reference frame, but each reference frame can have any number of dimensions.

Returning to FIG. 10, a transformation can be used to change poses in the IO frame into the VIO frame. The transformation between the VIO frame and the IO frame can be determined by identifying a pose in each frame that correspond to the same physical position. However, the VIO techniques and IO techniques may not start at the same time, and it may be necessary to normalize the time scales for each frame. For example, IO techniques may initialize and determine poses more quickly than VIO techniques, and, therefore, a first pose for a physical position in one frame may have a different timestamp than a second pose for the physical position in a second time frame. In some embodiments, the VIO frame may initialize and determine poses more quickly than the IO frame. This delay between poses in the two frames can be represented by ta and a pose in the IO frame 1006 that is equivalent to a pose in the VIO frame 1004 at time t can be represented by the following notation: IO(t−t_{d})_{IO} The transformation can be determined by comparing the equivalent poses in each reference frame. For example, if the VIO pose (e.g., the pose in the VIO frame 1004) at time t is a first set of x,y,z-coordinates at (5, 2, 7) and the equivalent IO pose (e.g., the pose in the IO frame 1006) at time t−t_{d} is a second set of coordinates at (7, 2, 5), then the transformation can be an angle of rotation around the y-axis. In this example, the transformation is a rotation, but, in some embodiments, the transformation may include any combination of a rotation around any number of axes, a change in scale along any number of axes, and a change in origin on any number of axes.

### C. Compensating for IO Bias (Direction and Speed)

Inertial odometry (IO) techniques may be used to determine a device's displacement when visual inertial odometry (VIO) techniques become unreliable. However, the displacement and poses projected by IO techniques are less accurate than those determined through VIO techniques. VIO techniques determine the mobile device's pose relative to features identified in a series of images. The displacement is then determined by comparing these poses. IO techniques may determine displacement by providing the output of various motion/magnetometer sensors to a pedestrian dead reckoning (PDR) algorithm. This PDR algorithm translates sensor outputs into an estimated displacement of the device based on a model that estimates human movement. The poses are then determined using this displacement. The PDR algorithm's predicted displacement may be less accurate than the poses and displacement determined by VIO techniques, and, using IO techniques, each subsequent pose is determined based on the displacement from a preceding pose. Accordingly, errors in a pose propagate to subsequent poses and IO techniques can become less accurate as these errors accumulate.

IO techniques can be made more accurate by calculating a bias for the displacements projected with these techniques. The bias can be calculated when both IO and VIO techniques are available. Poses determined by VIO techniques can be compared to corresponding poses determined by IO techniques. Any discrepancy between poses calculated by the VIO techniques and the IO techniques can be used to determine a bias for the IO techniques. For example, if the distance projected by the IO techniques is 90% as long as the distance projected by the VIO techniques, the bias for the IO distance can be set at 1/90%. The bias can be calculated based on a single discrepancy or an average discrepancy over any number of samples or any length of time period. The bias can include separate biases that are calculated for distance, speed, or angle along any number of axes.

The bias can be applied to displacements and poses calculated by IO techniques when VIO techniques are unreliable or unavailable. If the VIO techniques are unavailable or unreliable (e.g., VIO fails), the bias can be used to correct the displacements or poses determined using IO techniques. In some embodiments, the bias can be used to indicate uncertainty with the displacement or pose calculated with either IO or VIO techniques. In some embodiments, a discrepancy between VIO and IO projections can be used to determine the bias if the discrepancy is below a threshold, but the discrepancy may be used to determine that the VIO results are unreliable if the discrepancy is above the threshold. For example, if the magnitude of the discrepancy is below 50% (e.g., the displacement calculated by IO is at least 50% of the VIO displacement), then the discrepancy may be designated as the bias. If the magnitude of the discrepancy exceeds 50%, then one or more of the IO or VIO techniques may be designated as unreliable. For example, if the IO displacement (e.g., the displacement determined by IO techniques) is 40% of the VIO displacement, then the IO techniques may be designated as unreliable. Any number of thresholds can be used, and, for example, a first threshold can be used to identify unreliable displacements and a second threshold can be used to identify a bias. In some embodiments, the threshold can be different for VIO or IO displacements.

### D. Spliced Reference Frame

The mobile device may make multiple switches between odometry techniques. For example, a mobile device may use a first instance of performing visual inertial odometry (VIO) techniques to determine its displacement, switch to performing IO techniques when the first instance of performing VIO techniques became unreliable, and then switch to a second instance of performing VIO techniques when performing VIO techniques is reliable again. Each switch between odometry techniques may involve a transformation between reference frames, and separate instances of the same odometry technique may have different reference frames. Continuing the example above, the reference frame can be different for the first and second instances of performing VIO techniques. The errors of each instance that an odometry technique is performed can accumulate and these errors, along with errors in the transformations, can cause the reference frame to change over time. Accordingly, the reference frame may be a spliced reference frame that represents a fusion of the different reference frames used during tracking.

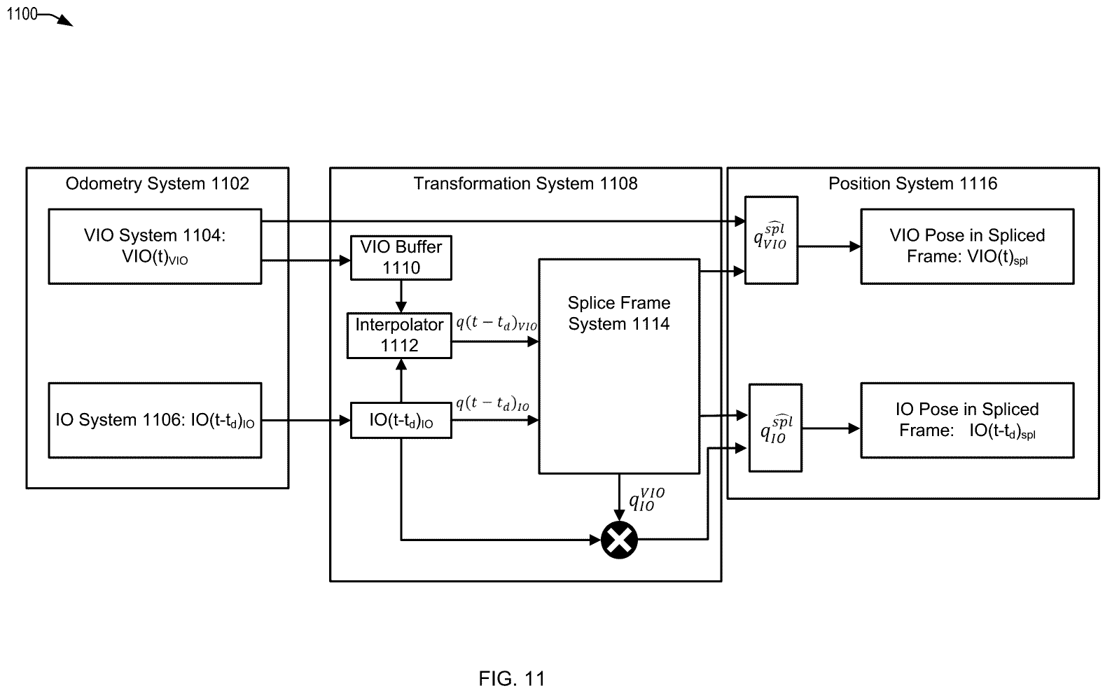

FIG. 11 is a simplified diagram 1100 of an architecture for transforming between reference frames according to various embodiments. As shown in diagram 1100, the transformations are operations that rotate a pose in a first reference frame to a pose in a second reference frame. However, other transformations are possible, and the transformations can include operations to use coordinates in a first reference frame to determine coordinates in a second reference frame when the scale or origin of one or more axes are different between the two reference frames.

Turning now to FIG. 11 in greater detail, odometry system 1102 can use the output from a mobile device's sensors to determine the device's pose over time. The pose over time can be a series of poses (e.g., position and orientation) at discrete points in time, a continuous displacement, or a series of net displacements with each displacement corresponding to a time period. A displacement can be a change in position and orientation from a first pose to a second pose. The odometry system 1102 can compare sequential images (e.g., visual information), and the output from inertial sensors (e.g., inertial information), to determine VIO system 1104 within a VIO reference frame. The VIO system 1104 can determine poses as a function of time (t), and the function can be represented with the following notation:

VIO(t)_{VIO}

Where the subscript VIO indicates that the pose is determined within a VIO reference frame.

The odometry system 1102 can use inertial sensor output to determine an IO pose as a function of time. The following notation can be used to represent the IO pose within an IO frame:

IO(t−t_{d})_{IO}

Where the subscript IO indicates that the pose is determined within an IO reference frame. The VIO system 1104 and the VIO system 1104 may output poses at different times. When compared to the IO system 1106, it may take longer for the VIO system 1104 to initialize and begin outputting poses. In addition or alternatively, the VIO system 1105 may take longer to provide an output for a given input.

The outputs from VIO system 1104 and IO system 1106 at a given time (t) may correspond to different input times. This discrepancy in output times can be corrected by subtracting a time delay from either the VIO system 1104 or the IO system 1106. For example, the IO system can begin outputting poses at t₀, but the VIO system 1104 may not be initialized and ready to output poses until (t₀+t_{d}). Once the VIO system 1104 is initialized, the system may begin to determine outputs for queued input. Accordingly, a pose for inputs that were measured at a given time period may be output at different times by the two systems. This discrepancy in output times can be addressed by the interpolator 1112 that can interpolate the VIO input at (t₀−t_{d}). After this interpolation, the VIO inputs and the IO inputs can both correspond to a same point in time.

The outputs from the odometry system 1102 can be provided to the transformation system 1108. The transformation system 1108 can determine transformations between reference frames. For example, the transformations shown in diagram 1100 include three dimensional rotations (e.g., quaternions). The output from the odometry system 1102 may need to be processed before a transformation can be determined. For example, the output of VIO system 1104 can be discrete while the output of the IO system 1106 may be continuous. In order to compare the outputs of these two systems, the transformation system 1108 may need to project continuous data for (e.g., interpolate) the output of the VIO system 1104.

The output of VIO system 1104 can be stored in a VIO buffer 1110 as a series of discrete poses. These discrete poses can be calculated at regular intervals (e.g., at each image frame's capture), and the difference between two sequential poses can represent the net change in position during the interval between the two poses. In contrast, the output of the IO system 1106 can be a continuous position that estimates the mobile device's displacement over time. The interpolator 1112 can use the discrete poses in VIO buffer 1110, and the displacement output by IO system 1106, to estimate a displacement for the mobile device performing the operations disclosed in reference to diagram 1100. The interpolator can be used to find a interpolated VIO output that corresponds to each IO measurement's timestamp. The interpolator may also alter the displacement to account for differences in the timeframes used by the VIO system 1104 and the IO system 1106 (e.g., so that t_{IO} and t_{VIO} are equivalent).

After the VIO output is interpolated, the IO output and the interpolated VIO output can be provided to the splice frame system 1114. These outputs can be provided as one or more quaternions in a common timeframe. A quaternion representing a rotation of θ radians about the unit axis (X, Y, Z) can be represented by:

$$( cos ( \frac{θ}{2} ) , X sin ( \frac{θ}{2} ) , Y sin ( \frac{θ}{2} ) , Z sin ( \frac{θ}{2} ) )$$

The quaternion can be a combination of the unit axis and the rotation about the unit axis can represent a transformation between a point in one reference frame and a point in another frame. The splice frame system 1114 can determine a rotation from the IO frame to the spliced frame (spl), and this rotation can be represented as a unit quaternion with the following notation:
[symbol] The splice frame system 1114 can determine a rotation from the VIO frame to the spliced frame (spl), and this rotation can be represented by a unit quaternion with the following notation:

[symbol]

Initially, the spliced frame can be the VIO frame, and the first rotation calculated by the splice frame system may be a rotation from an initial IO frame to an initial VIO frame that is designated as the initial spliced frame. For example, the VIO output may become unreliable, and the rotation may facilitate a switch from VIO navigation to IO navigation. Continuing the example, the VIO output may become reliable again, but the second VIO frame may be different from the initial VIO frame. In response, the splice frame system 1114 may calculate a rotation from the second VIO frame to the spliced frame so that the device can return to VIO navigation. The IO system 1106 may output an altitude and a second change in velocity (generated without pedestrian dead reckoning) that may be present event when other output from the IO system is not available. The quaternion for the altitude and change in velocity may be applied separately from the quaternions for other output of the IO system 1106. These quaternions can be combined in a splicing block represented by a black circle with a white “X” in FIG. 11.

The output of the splice frame system 1114 and the output of the odometry system 11102 are provided to the position system 1116. The position system 1116 can use the output of the VIO system 1104 and the quaternion unit vector q_{IO}^{s̅p̅l̅} output by the splice frame system 1114 to calculate the VIO pose in the spliced frame VIO(t)ₛₚₗ. For example, positions in the VIO frame can be conjugated by the quaternion unit vector to determine equivalent positions in the splice frame. The position system 1116 can use the output of the IO system 1106 and the quaternion unit vector q_{VIO}^{s̅p̅l̅} output by the splice frame system 1114 to calculate the IO pose in the spliced frame IO(t)ₛₚₗ. For example, positions in the IO frame can be conjugated by the quaternion unit vector to determine equivalent positions in the splice frame.

### E. Transitions Between Reference Frames

A transformation, such as a quaternion, can be calculated at transitions between odometry techniques. For example, a transformation can be calculated when unreliable VIO information becomes reliable again. However, not all changes in odometry techniques may cause the transformation system to calculate a transformation.

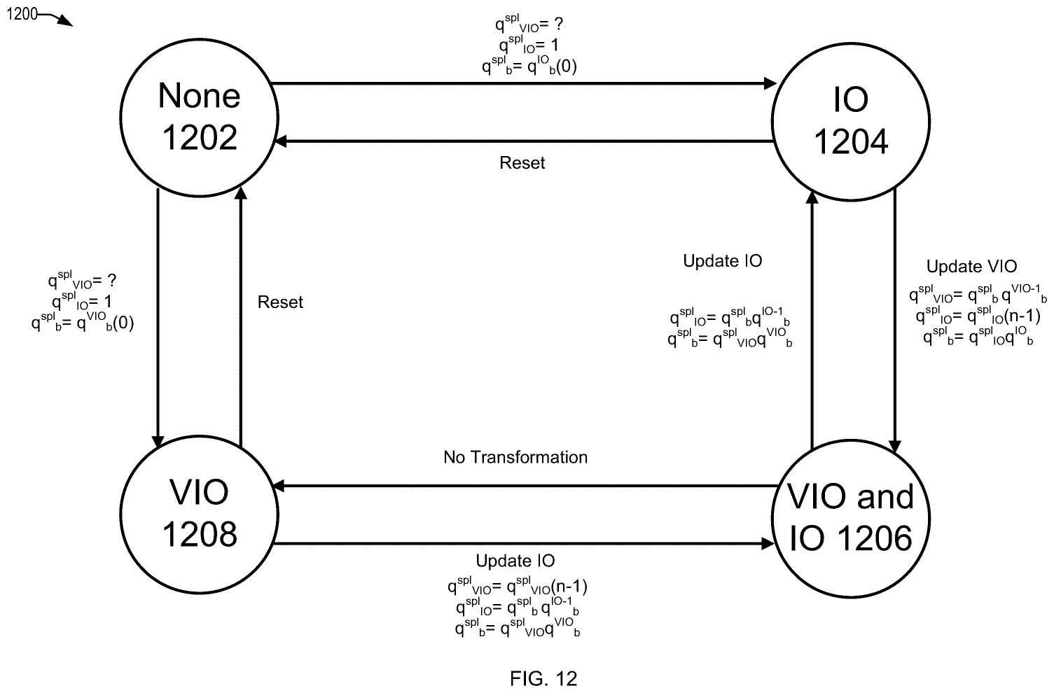

FIG. 12 is a simplified state diagram showing events that trigger determining transformations between reference frames according to various embodiments. Block 1202 can represent the state of a device that is not performing either IO or VIO techniques. For example, block 1202 may represent the state of a device before odometry techniques are requested by a user. As discussed above, IO techniques may initialize quicker than VIO techniques, and the state of the device may initially proceed to block 1204 in response to a request for odometry techniques. In such circumstances, the IO reference frame can be designated as the spliced reference frame and the transition between the body frame to the spliced frame q_{b}^{spl} equal to the transition between the body frame and the current IO frame q_{b}^{IO}. Because VIO techniques are not being performed in the states represented by block 1202 or block 1204, there is no VIO frame, and, accordingly there is no need for a transformation between the VIO frame and the spliced frame q_{VIO}^{spl}. Also, there is no need to calculate a transformation for a transition from block 1204 to block 1202 because no odometry techniques are performed by a device in the state represented by block 1202.

As discussed above, IO techniques may be initialized before VIO techniques become available. A device performing IO techniques can transition from the state represented by block 1204 to the state represented by block 1206 if VIO techniques become available in addition to the IO techniques. A technique can be available if a device can perform the technique and receive reliable output for that technique.

Transformations may be calculated when a device transition from the state represented by block 1204 to the state represented by block 1206. For example, the transition between these blocks means that the device has access to reliable VIO outputs, and, in such a state, the device's position may be estimated using VIO techniques. These VIO outputs may be provided as positions or displacements in a VIO reference frame. However, past positions are recorded in the spliced reference frame (e.g., spliced frame). A transformation from the VIO reference frame to the spliced frame q_{VIO}^{spl} can be determined by multiplying the rotation from the body frame to the spliced frame q_{b}^{spl} by the conjugation of the rotation from the body frame to the current VIO frame (q_{b}^{VIO})⁻¹. The IO reference frame may remain the same at block 1204 and block 1206. Accordingly, the transformation from the IO reference frame (e.g., IO frame) to the spliced reference frame may be the same at block 1204 and block 1206 (e.g., q_{IO}^{spl}=q_{IO}^{spl}(n−1)).

The device may transition from the state represented by block 1206 to the state represented by block 1204. The spliced reference frame may have changed in response to using VIO techniques at block 1206 and a transformation from the IO reference frame to the spliced reference frame can be determined by multiplying the rotation (e.g., the transformation) from the body frame to the spliced frame q_{b}^{spl} by the conjugation of the rotation from the body frame to the current IO frame (q_{b}^{IO})⁻¹.

The device may transition from the state represented by block 1206 to the block represented by block 1208. In this state, the device may only have access to the output of VIO techniques. However, because VIO techniques are used to determine the device's position in both states, there may not be a need to calculate a transformation in response to this transition. However, a transformation from the current IO reference frame to the spliced frame may be calculated if the device transitions from block 1208 to block 1206. The transformation between VIO frame and the spliced frame may remain the same (e.g., q_{VIO}^{spl}=q_{VIO}^{spl}(n−1), and the transformation between IO frame and the spliced frame can be determined by multiplying the rotation (e.g., the transformation) from the body frame to the spliced frame q_{b}^{spl} by the conjugation of the rotation from the body frame to the current IO frame (q_{b}^{IO})⁻¹.

The device may transition from the state represented by block 1208 to the state represented by block 1202. This transition can occur when VIO becomes unreliable and IO techniques are unavailable. In such a circumstance, no odometry techniques are performed and the device may reset because the device is not tracking its position in any reference frame. If the device transitions from block 1202 to block 1208, the device begins to perform VIO techniques and determine the device's position in a current VIO reference frame. Accordingly, the VIO reference frame can be designated as the spliced reference frame and the transition between the body frame to the spliced frame q_{b}^{spl} is equal to the transition between the body frame and the current VIO frame q_{b}^{VIO}. Because IO techniques are not being performed in the states represented by block 1202 or block 1204, there is no IO frame, and, accordingly there is no need for a transformation between the IO frame and the spliced frame q_{IO}^{spl}.

### F. Flow

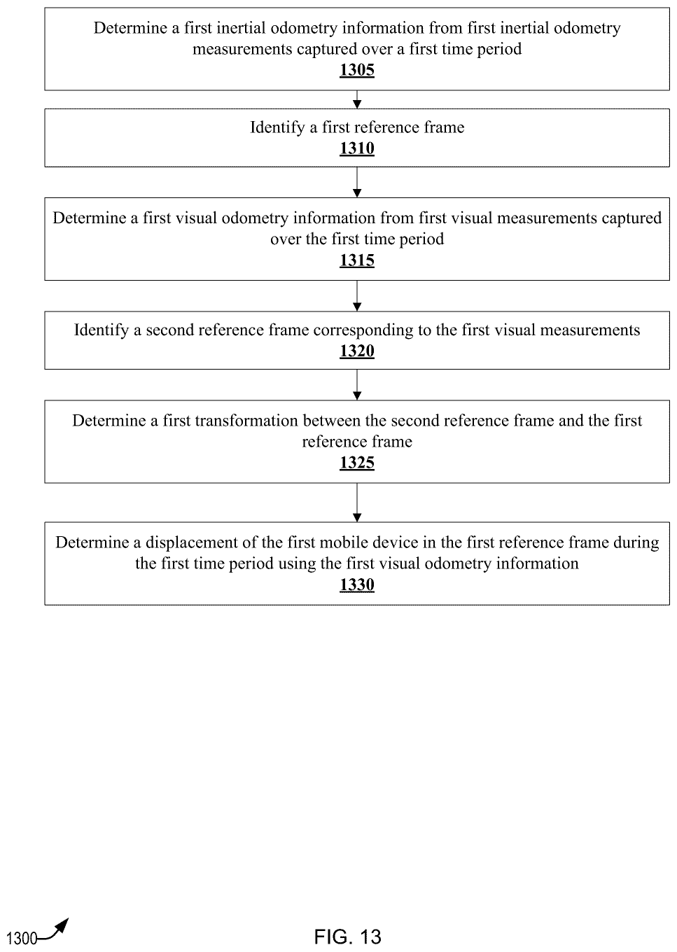

FIG. 13 is a flow chart of a process 1300 for transforming between reference frames, according to an example of the present disclosure. According to an example, one or more process blocks of FIG. 13 may be performed by a mobile device.

At block 1305, a first inertial odometry information can be determined from first inertial measurements. The first inertial measurements can be captured over a first time period using an inertial sensor on the mobile device. The inertial sensors can include one or more accelerometers, and, for example, the inertial sensors can be three accelerometers that are arranged at orthogonal axes. In addition or alternatively, the inertial sensors can include any number of magnetometers or gyroscopes and these sensors can be arranged along any number of axes. The inertial information can be discrete or continuous, and, for example, the inertial information can be the continuous domain output of some or all of the inertial sensors over the first time period.

At block 1310, a first reference frame corresponding to the first inertial measurements can be identified. The first reference frame can be the IO frame of reference, and the first frame of reference can be a three-dimensional coordinate system. The first reference frame can be a spliced reference frame in various embodiments.

At block 1315, a first visual odometry information can be determined from first visual measurements captured over the first time period. The first visual measurements can be captured by a visual sensor of the first mobile device. The first visual measurements can be image frames captured by the visual sensor, or the first visual measurements can be one or more identified features from image frames. The first visual odometry information can be one or more positions for the first mobile device and each of the one or more positions can correspond to a position of the first mobile device during the capture of an image frame.

The first visual sensor can be one or more cameras and the cameras can be part of the first mobile device. In some embodiments, the first visual sensor can be one or more cameras on an electronic device that is communicably connected (e.g., a wired connection or a wireless connection) to the first mobile device. For example, the first visual sensor can be one or more cameras on a wearable device such as smart glasses, headphones, etc. In some embodiments, the first mobile device is a virtual reality device or an augmented reality device.

At block 1320, a second reference frame corresponding to the first visual measurements can be captured. The second reference frame can be a VIO reference frame.

At block 1325, a first transformation between the second reference frame and the first reference frame can be determined. The first transformation can be a rotation around one or more axes. For example, the first transformation can be a quaternion rotation or a rotation matrix. In some embodiments, the transformation can include one or more of a change in scale around one or more axes or a change in the origin along one or more axes.

At block 1330, a displacement of the first mobile device in the first reference frame can be determined. The displacement can be determined for the first time period and the displacement can be determined using the first visual odometry information from block 1315 and the transformation from block 1325. The displacement can be one or more poses for the first mobile device during the first time period or the displacement can be a continuous path for the first mobile device during the first time period.

Determining the displacement of the first mobile device in the first reference frame can comprise mapping the first visual odometry information onto the second reference frame based on the transformation. Mapping can mean applying the transformation from block 1325 to the first visual odometry information. The first visual odometry information can be any combination of a displacement or one or more poses in the second reference frame. Once mapped, the first inertial information and the second inertial information can be compared to determine an error of the first inertial odometry information during the first time period. The error can be a percentage difference between any combination of the poses or displacements corresponding to the first inertial information and the poses or displacements corresponding to the first visual odometry information.

The first inertial odometry information can be transformed by the error of the first inertial odometry information to obtain transformed first inertial odometry information. For example, if the error indicates that the first inertial odometry information produces a displacement with a magnitude that is 80% of the magnitude determined by the first visual odometry information (e.g., the error is 0.80), then the displacement represented by the first inertial odometry information can be divided by the error to determine the transformed first inertial odometry information. The displacement of the first mobile device in the first reference frame can be determined based on any combination of the transformed first inertial odometry information or the first visual odometry information. The error can be an error in the output of the inertial sensors. For example, the error can be a percentage difference between the acceleration, velocity, or magnetometer readings output by the inertial sensors. There may be a separate error for the acceleration, velocity, or magnetometer readings in any number of axes.

The techniques may include determining a second inertial odometry information from the second inertial measurements over a second time period occurring after the first time period. The second inertial odometry information can be determined using the error of the first inertial odometry information (e.g., the output of the inertial sensors, or the displacement, can be corrected by the error). A second visual odometry information can be determined over the second time period.

The second inertial odometry information and the second visual odometry information can be compared to determine if the second visual odometry information is unreliable. For example, poses from the second inertial odometry information and the second visual odometry information can be compared to determine that the second visual odometry information is unreliable. For example, the visual odometry information may be unreliable if the visual odometry information indicates that the mobile device is stationary, but the inertial odometry information indicates that the device has moved.

In some cases, the second visual odometry information can be identified as unreliable by comparing the second visual odometry information to thresholds without comparing the second visual odometry information to the second inertial odometry information. For example, the second visual odometry information may be unreliable if the displacement between sequential poses is sufficiently large. In some embodiments, visual odometry information may be identified as unreliable if the visual measurements used to generate the visual odometry information fail to satisfy one or more visual measurement thresholds. For instance, image frames in the visual measurements may fail to satisfy the visual measurement thresholds if the brightness of the image frame is below a threshold, if the brightness of the image frame is above a threshold, if the signal to noise ratio of the image frame is below a threshold, the number of features identified in the image frame is below a threshold, etc.

The mobile device may stop using the second visual odometry information during the second time period in response to determining that the second visual odometry information is unreliable over the second time period. The mobile device may switch to using the second inertial odometry information for determining the displacement of the first mobile device in the first reference frame in response to determining that the second visual odometry information is unreliable. The mobile device may use the second inertial odometry information to determine the displacement during the second time period. The mobile device may use the first transformation, the inverse of the first transformation, or a different transformation to determine the displacement of the first mobile device in the first reference frame.

The mobile device may perform third visual measurements during the second time period or a third time period after the second time period. The third visual measurements may be used to determine a third visual odometry information, and, if the third visual odometry measurements are determined to be reliable, the mobile device may use the third visual odometry information to determine the displacement of the mobile device during the third time period. Determining the displacement in the first reference frame may include determining a second transformation between a third reference frame corresponding to the third visual measurements and the first reference frame.

In various aspects, a mobile device, can include one or more processors and a memory coupled to the one or more processors. The memory can store instructions that cause the one or more processors to perform any one or more of the operations as described above.

In various aspects, a non-transitory, computer readable medium can be stored instructions that when executed on one or more processors perform any one of more of the operations as described above

It should be noted that while FIG. 13 shows example blocks of process 1700, in some implementations, process 1300 may include additional blocks, fewer blocks, different blocks, or differently arranged blocks than those depicted in FIG. 13. Additionally, or alternatively, two or more of the blocks of process 1300 may be performed in parallel.

### V. Fusion of People Finding Techniques

Mobile devices have various different capabilities for finding other mobile devices. In certain circumstances a people finding technique may not be effective and the mobile device either use another technique or look to combine the positions obtained from various techniques. For example, GNSS-based systems may have interference in urban areas, indoors, or in areas of dense foliage. In these cases, other people finding techniques can be used alone or in combination with the GNSS position. Various different combinations are discussed below.

A. Problems with Interference and Causes of Uncertainty

GNSS-based navigation systems are often used to determine a location of mobile devices. GNSS-based system, such as GPS (Global Positioning System), GLONASS, Galileo, and BeiDou, can rely on precise and accurate signals from satellites to determine positions on Earth. However, these signals can be subject to various noise issues, which can affect the performance and accuracy of GNSS navigation. Some common noise issues in GNSS navigation signals can include multi-path interference, atmospheric interference, signal blockage, receiver noise, interference, and clock drift.

Multipath Interference can occur when the GNSS signals reflect off surfaces, such as buildings, vehicles, or terrain, before reaching the receiver antenna. The reflected signals can interfere with the direct signals, causing errors in the position estimation. Multipath interference can be more prevalent in urban environments with tall buildings and can result in position inaccuracies.

Atmospheric interference can introduce noise as the GNSS signals pass through the Earth's atmosphere, and various atmospheric conditions can introduce noise. For instance, ionospheric delays can cause signal refraction, leading to errors in signal travel time estimation. Similarly, tropospheric conditions, such as temperature and humidity variations, can cause signal attenuation and delay. These atmospheric effects can impact the accuracy of GNSS positioning.

Signal Blockage can present issues when buildings, dense foliage, and natural features like mountains or canyons can obstruct the line of sight between the satellites and the receiver antenna. When the line of sight is blocked, the received signals may be weakened or completely lost, resulting in degraded or intermittent GNSS signal reception.

The GNSS receiver itself can introduce noise into the received signals, which can degrade the accuracy of position estimation. Receiver noise can arise from various sources, such as internal electronics, thermal effects, and electromagnetic interference. High-quality GNSS receivers employ techniques to minimize receiver noise and enhance the signal-to-noise ratio.

GNSS signals operate in the radio frequency spectrum, and they can be susceptible to interference from other mobile devices or radio transmissions. Radio frequency interference (RFI) from nearby devices operating in the same frequency range can disrupt the GNSS signals, leading to positioning errors.

Accurate timing is crucial in GNSS navigation and clock drift can present issues. The satellite signals carry precise timing information, and any clock discrepancies between the satellite and the receiver can introduce errors. Clock drift in the receiver or satellite clocks can lead to inaccuracies in the calculated position.

To mitigate these noise issues, various techniques can be employed, such as antenna design optimization, signal processing algorithms, and the use of multiple GNSS constellations for improved positioning accuracy. Additionally, differential GNSS techniques, where a stationary reference receiver provides corrections to a mobile receiver, can help mitigate some noise issues and improve positioning accuracy in real-time applications. Mobile devices can determine the uncertainty values between GNSS techniques and other localization techniques (e.g., ranging, RSSI determination, etc.) when GNSS becomes unreliable.

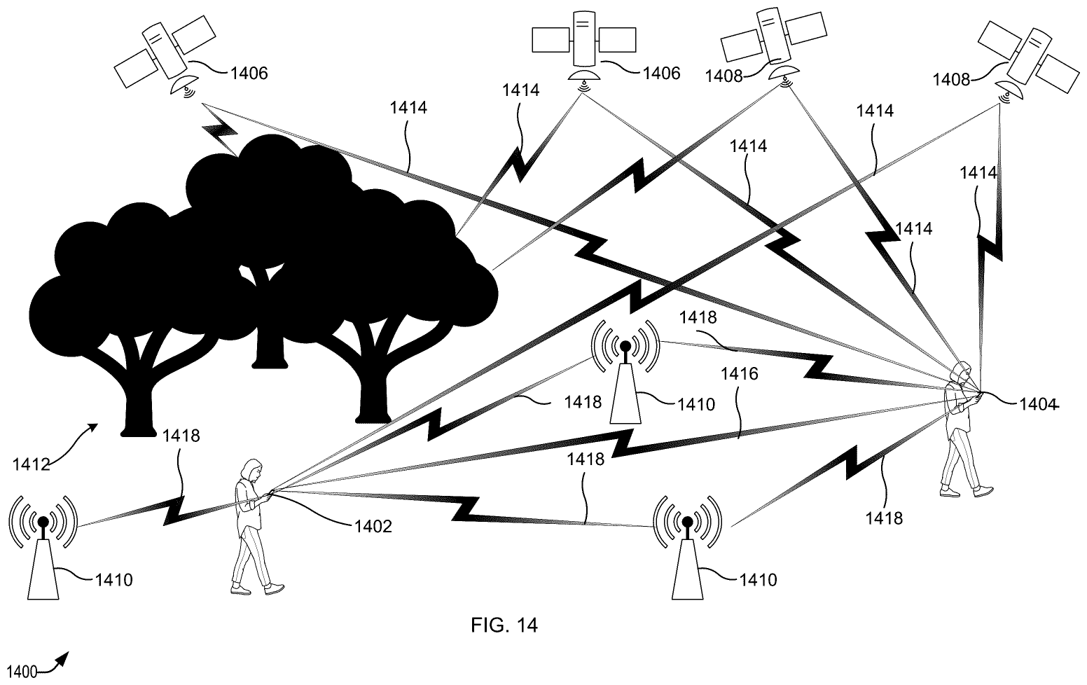

FIG. 14 illustrates a first user with first mobile device 1402 attempting to locate a second user with a second mobile device 1404. A plurality of satellites 1406 can transmit timing signals 1414 that can normally be received at an antenna of a mobile device. The mobile devices can use the timing information to determine a position of the mobile device.

While four satellites 1406 are illustrates in FIG. 14 additional satellites 1406 can be in view of the mobile device. For example, the number of GPS satellites in view at any given location and time varies depending on several factors, including the location on Earth, the time of day, and the surrounding environment. However, the GPS satellite constellation currently consists of a total of 24 operational satellites.

To provide accurate positioning, a GPS receiver typically requires signals from a minimum of four satellites. With signals from four satellites, the receiver can perform trilateration to determine the receiver's position in three-dimensional space (latitude, longitude, and altitude), as well as the precise time.

In practice, the number of GPS satellites in view can vary between four and more depending on the receiver's location. In open areas with an unobstructed view of the sky, it is common to have a larger number of satellites in view simultaneously. For example, in ideal conditions, it is possible to have between six to twelve or even more satellites in view.

FIG. 14 illustrates and area of dense foliage 1412 that can block or introduce noise for the timing signals 1414 from the satellites 1406. As shown in FIG. 14, the dense foliage 1412 can reduce the timing signals 1414 received by the first mobile device making GPS position inaccurate, unreliable, or potentially unavailable. However, the second mobile device 1404 may be able to receive the timing signals 1414 from the various satellites 1406. The second mobile device 1404 may be able to determine an accurate position.

The first mobile device 1402 and second mobile device 1404 may be able to calculate relative positions using other positioning techniques (e.g., ranging techniques) by wireless communication 1416 between the devices.

Other wireless transmitters 1410 can also be withing range of the first wireless device 1402 and the second wireless device 1404. Various positioning techniques (e.g., Wi-Fi positioning, LTE positioning, or 5G positioning) can be used by the mobile device. The wireless transmitters 1410 illustrated in FIG. 14 can include Wi-Fi access points (AP), LTE cellular towers, or 5G cellular towers.

Positioning techniques using Wi-Fi signals, commonly known as Wi-Fi positioning or Wi-Fi-based localization, utilize the signals from Wi-Fi APs to estimate the location of a mobile device. Signal Strength-Based Localization involves measuring the received signal strength (RSS) from nearby Wi-Fi APs. A database, often referred to as a radio map or fingerprint database, is created by collecting RSS values at known locations. The database contains information about the locations of Wi-Fi APs and their corresponding RSS fingerprints.

In offline mode, the mobile device can collect RSS measurements from nearby APs and matches them against the stored fingerprint database to estimate its location. The best match between the measured RSS values and the stored fingerprints determines the device's position.

In online mode, the mobile device can send the measured RSS values to a server or cloud-based infrastructure that performs the matching process. The server compares the measured RSS values with the stored fingerprints and returns the estimated location to the device.

Triangulation or Trilateration techniques can be used to estimates the mobile device's position based on the distances or angles between the device and multiple Wi-Fi APs. The distances between the mobile device and multiple APs can be estimated using RSS values or signal propagation models. With distance information, techniques such as trilateration or multilateration can be employed to calculate the device's position. By measuring the angle of arrival (AOA) or time difference of arrival (TDOA) of Wi-Fi signals from different APs, the device's position can be estimated using techniques like triangulation or angle of arrival.

Combining Wi-Fi positioning with other positioning technologies, such as GPS, cellular networks, or sensor fusion, can enhance accuracy, reliability, and coverage. By integrating multiple sources of positioning data, the device can achieve improved performance in various scenarios.

Combining Wi-Fi signals with data from other sensors, such as accelerometers, gyroscopes, magnetometers, or barometers, allows for more robust positioning and compensation for environmental factors.

Leveraging additional information, such as GPS assistance data or cellular network data, can assist in the Wi-Fi positioning process and enhance accuracy, especially in challenging environments where Wi-Fi signals may be limited. Wi-Fi-based positioning has limitations, including signal interference, multipath effects, changes in the environment, and the need for an up-to-date database. Furthermore, the accuracy of Wi-Fi-based positioning can vary depending on the density and distribution of Wi-Fi APs, signal quality, and environmental factors.

LTE (Long-Term Evolution) signals, commonly used for mobile communication, can also be utilized to estimate the location of a mobile device. The process involves measuring the signal characteristics and leveraging cell tower information. The mobile device can measure the received signal strength (RSS) from nearby LTE base stations (cell towers). The RSS values can indicate the relative proximity of the device to different towers. A database or network infrastructure contains information about the locations and characteristics of the LTE cell towers. This information includes tower coordinates (latitude and longitude) and unique identifiers (Cell ID, eNodeB ID).

The mobile device can identify the serving cell tower and neighboring towers based on the measured RSS values. This step helps determine the possible tower candidates contributing to the device's signal reception. In the case of LTE, trilateration is performed using the identified cell towers and their known coordinates to estimate the device's location by measuring distances from known reference points.

The distance between the mobile device and each candidate cell tower can be estimated based on factors like received signal strength, signal propagation models, and path loss calculations. Once the distances to at least three towers are determined, trilateration algorithms can be applied to calculate the device's location. By intersecting the circles (or spheres in three dimensions) with radii equal to the estimated distances from the towers, the device's position can be estimated. To improve accuracy, additional techniques can be employed such as Time Difference of Arrival (TDOA) and Signal Fingerprinting.

Using Time Difference of Arrival (TDOA) techniques the mobile device can measure the time it takes for the signal to travel from the device to different towers, TDOA techniques can further refine the location estimation.

Signal Fingerprinting can include collecting signal propagation data from known locations, a database of signal fingerprints can be created. Comparing the current signal characteristics with the database, the device's location can be determined based on the closest match.

The accuracy of location estimation using LTE signals can vary depending on several factors, including signal strength, signal quality, the density of cell towers, and environmental conditions. Additionally, network infrastructure and access to the necessary databases are crucial for performing accurate location estimation using LTE signals.

Calculating an accurate position of a mobile device using 5G signals typically involves similar principles as with LTE, but with potential enhancements in accuracy and capabilities. The mobile device can measure various parameters of the 5G signals it receives, such as signal strength, signal time of arrival (TOA), signal delay, and signal phase. These measurements are used to gather information about the nearby 5G base stations (gNodeBs) and their signals.

Similar to LTE, there is a database or network infrastructure that contains information about the locations and characteristics of the 5G gNodeBs. This database includes gNodeB coordinates (latitude and longitude) and unique identifiers.

The mobile device can identify the serving gNodeB and neighboring gNodeBs based on the measured signal parameters. This step helps determine the possible gNodeBs that are contributing to the device's signal reception. Trilateration or multilateration techniques can be used to estimate the device's location based on the identified gNodeBs and their known coordinates. The distance or time difference of arrival (TDOA) between the mobile device and each candidate gNodeB is estimated using signal parameters and propagation models. Advanced techniques such as angle of arrival (AOA) or phase-based measurements can be used to enhance accuracy. Once the distances or TDOA to at least three gNodeBs are determined, trilateration or multilateration algorithms can be applied to calculate the device's position. By intersecting circles or spheres (or hyperbolas in the case of TDOA) with radii or time differences equal to the estimated distances, the device's position can be estimated.

Similar to LTE, various refinement techniques can be used to improve accuracy. Combining 5G signals with other positioning technologies such as GPS, Wi-Fi, or sensor fusion can enhance accuracy and reliability. Building a database of signal fingerprints from known locations can help match the current signal characteristics to estimate the device's location accurately. Leveraging advanced signal processing techniques and algorithms, such as beamforming and massive MIMO, can improve the accuracy and robustness of 5G-based positioning.

The accuracy of position estimation using 5G signals can be influenced by factors such as signal quality, multipath interference, obstructions, and the availability of infrastructure and databases. Additionally, the deployment of advanced features in 5G networks, such as higher frequency bands, beamforming, and advanced antenna arrays, can potentially improve the accuracy and reliability of 5G-based positioning.

### B. Using Uncertainty to Determine Fusion of Position Techniques

The mobile device can calculate uncertainty for each of the various techniques that can be used by a first mobile device to find a second mobile device. The uncertainty values can vary based on the environment, the location, or even the mobile device. The uncertainty values can be used by the first mobile device to select the specific technique for finding the second device. In various embodiments, the uncertainty values can be used to weigh a combination (e.g., an average) of the determined locations for the second mobile device. In various embodiments, the uncertainty values can be great enough that the mobile device disregards a given technique for finding the second mobile device.

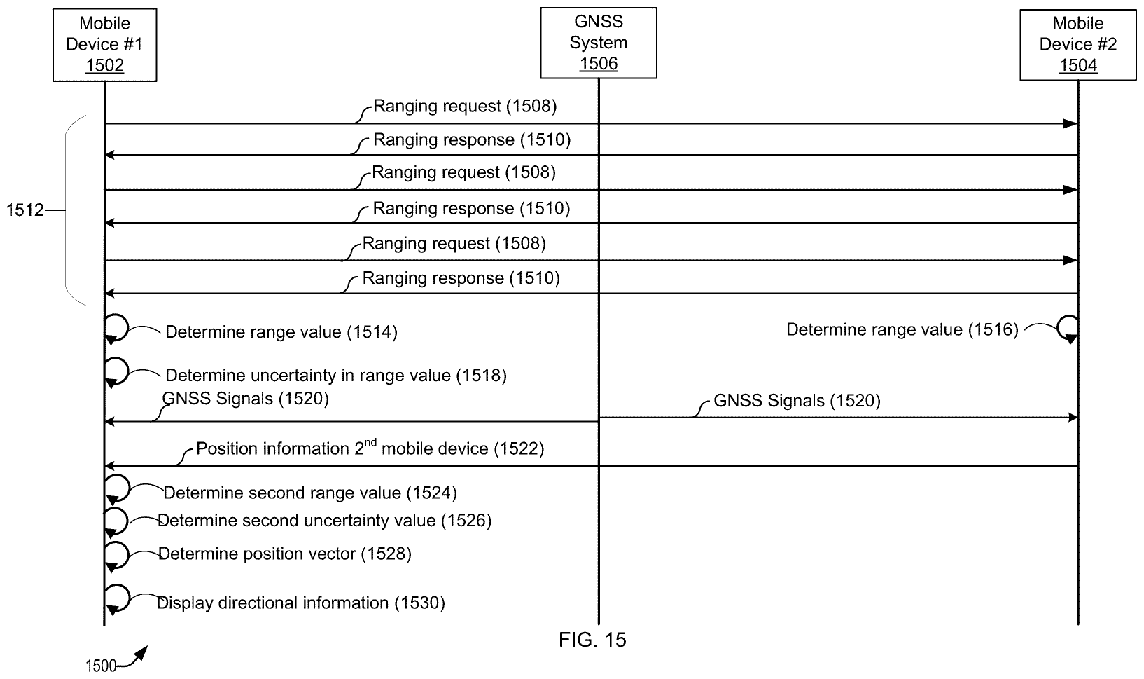

FIG. 15 illustrates a cross-functional flowchart 1500 for fusion of people finding techniques between a first mobile device 1502 and a second mobile device 1504. Both mobile devices participating in the ranging session are equipped with transceivers (e.g., UWB transceivers) capable of transmitting and receiving wireless signals (e.g., UWB signals). These transceivers can employ ultra-short pulses with a wide spectrum, enabling precise distance measurements.

At a first time, the first mobile device 1502 can transmit a first wireless signal. The first wireless signal can include a ranging request 1508. The ranging request 1508 can include an identifier for the first mobile device. In various embodiments, the ranging request 1508 can include a time of the ranging request 1508 transmission. The wireless ranging signal can be various wireless protocols (e.g., UWB, Bluetooth, BLE, Zigbee, Wi-Fi, etc.).

The second mobile device 1504 can receive the ranging request 1508 using a wireless transceiver. The second mobile device 1504 can store the time of the received ranging request and the identifier for the first mobile device. In various embodiments, the second mobile device 1504 can transmit a response message 1510. The response message 1510 can include the identifier of the first mobile device 1502. The response message 1510 can include a time of reception of the ranging request 1508 at the second wireless device 1504. The response message 1510 can include an identifier of the second wireless device 1504. The response message 1510 can include a processing or delay time. The processing or delay time can be estimated. The processing or delay time can be the time it takes for the second mobile device 1504 to receive, process, and transmit the response message 1510 after receiving the ranging request 1508. The processing or delay time can account for signal processing, pulse detection and time, data transmission time, and system latency.

The first mobile device 1502 can receive the response message 1510 at a second time.

At 1514, the first mobile device 1502 can determine a range value between the first mobile device 1502 and the second mobile device 1504 using the first transmission time and the second time to determine a time difference. The processing or delay time can be subtracted from the time difference to determine a time of flight (TOF) measurement. The time of TOF measurement can be used to determine a round trip distance between the first mobile device 1502 and the second mobile device 1504. The round trip distance can be halved to determine the range value between the first mobile device and the second mobile device.

FIG. 15 illustrates one ranging round 1512 consisting of three exchanges each having a ranging request 1508 and a ranging response 1510. Although three exchanges are illustrated, ranging rounds 1512 may have more or less exchanges between the mobile devices. Although, one ranging round 1512 is illustrated, many more ranging rounds may be depicted.

In various embodiments, the second mobile device 1504 can determine the range value between the first mobile device 1502 and the second mobile device 1504.

At 1518, the first mobile device can determine the uncertainty value in the range measurement. The first mobile device 1502 can evaluate the quality and reliability of the received wireless signal. Factors such as signal strength, signal-to-noise ratio (SNR), multipath effects, and interference levels can impact the accuracy of range measurements. By analyzing these signal quality parameters, the first mobile device 1502 can estimate the uncertainty associated with the range measurements.

Statistical methods can be employed to assess the variability and uncertainty in range measurements. The first mobile device 1502 can collect multiple range measurements over time and analyze them using statistical techniques such as standard deviation, variance, or confidence intervals. These statistical measures provide an estimation of the uncertainty or error range associated with the range measurements.

The uncertainty in range measurements can be propagated from various sources, including signal noise, timing errors, and hardware limitations. By considering the individual sources of uncertainty and their respective error contributions, the first mobile device 1502 can estimate the overall uncertainty in the range measurements through error propagation calculations.

Wireless systems often require calibration procedures to account for system-specific biases or inaccuracies. During calibration, the device can determine calibration uncertainty, which represents the uncertainty in the calibration process itself. This calibration uncertainty can be used to quantify the overall uncertainty in the range measurements.

The mobile device can consider environmental factors that may impact wireless range measurements. For example, variations in temperature, humidity, and electromagnetic interference can introduce uncertainties. By monitoring and accounting for these environmental factors, the first mobile device 1502 can estimate the associated uncertainty in range measurements.

If the first mobile device 1502 utilizes multiple positioning technologies, such as GPS, Wi-Fi, or sensor fusion, it can leverage the strengths of each technology to estimate uncertainty. By combining the wireless range measurements with other positioning data, the device can perform data fusion techniques, such as Kalman filtering or Bayesian estimation, to estimate the uncertainty in the final position estimate.

The first mobile device 1502 can receive GNSS signals 1520 using the GNSS system 1506. The first mobile device 1502 can use the received GNSS signals 1520 to determine a position of the first mobile device 1502. The position may not be accurate or may have high uncertainty due to the noise issues discussed above. The second mobile device 1504 can receive GNSS signal 1520 using the GNSS system 1506 and determine a second position of the second mobile device 1504.

The first mobile device 1502 can receive the position information 1522 of the second mobile device 1504 via a data channel between the first mobile device 1502 and the second mobile device 1504. In various embodiments, UWB devices can establish direct links with each other to exchange data or can operate in a broadcast mode where data is simultaneously transmitted to multiple devices within range.

The first mobile device 1502 can determine a second range value 1524 using the position of the first mobile device 1502 and the position information 1522 of the second mobile device.

The first mobile device 1502 can determine an uncertainty value 1526 of the range between the first mobile device 1502 and the second mobile device 1504 using the GNSS based position information.

Uncertainty in GNSS position information refers to the measure of potential error or lack of accuracy in determining the exact location using GNSS signals. The quality of the received GNSS signals affects the accuracy of position determination. Poor signal conditions, such as low signal strength, multipath interference, or signal blockage due to obstacles, can introduce errors and increase uncertainty. The geometric arrangement of the GNSS satellites in view of the receiver plays a crucial role in position accuracy. Ideally, a receiver should have a diverse set of satellites spread out in the sky to ensure better triangulation and improve accuracy. A poor satellite geometry, with satellites clustered in a specific region or a low number of visible satellites, can increase uncertainty.

The Earth's atmosphere can introduce errors in GNSS signals, primarily due to atmospheric delays and signal propagation effects. Factors such as ionospheric and tropospheric delays, which vary with weather and environmental conditions, can impact the accuracy of position determination, and contribute to uncertainty.

GNSS receivers themselves may introduce errors, including clock errors, receiver noise, multipath effects, and limitations in signal processing algorithms. These errors can affect the accuracy of position estimation and contribute to uncertainty.

GNSS receivers rely on precise information about the satellites' positions, orbits, and clock corrections, known as ephemeris and almanac data. Errors or outdated data in these parameters can lead to inaccuracies in position determination and increase uncertainty.

Differential GNSS techniques, such as using reference stations or satellite-based augmentation systems (SBAS), can improve accuracy by providing correction data. However, errors or inconsistencies in the differential corrections can still introduce uncertainty.

Errors in individual measurements, such as range measurements or satellite clock errors, can propagate through the positioning algorithms and accumulate, leading to increased uncertainty in the final position estimate.

To mitigate and quantify the uncertainty in GNSS position information, techniques such as error estimation, statistical analysis, and data fusion with other positioning technologies (such as sensor fusion or Wi-Fi positioning) can be employed. Additionally, utilizing advanced GNSS receivers with improved signal processing algorithms, multi-constellation support, and real-time corrections can enhance accuracy and reduce uncertainty in GNSS positioning.

The first mobile device 1502 can determine which positioning technique provides the lowest uncertainty value and select that technique for determining the location of the second mobile device 1504. For example, if the GNSS position has significantly more uncertainty than the ranging positioning technique, the position of the second mobile device using the ranging techniques can be used. If the ranging position has significantly more uncertainty than the GNSS derived position for the second mobile device, the GNSS derived position can be used.

In various embodiments, each of the various positioning techniques can be used. The position determined for each technique can be averaged to determine an approximately position of the second mobile device 1504. In various embodiments, each of the various positioning techniques can be weighted prior to determining the average. In various embodiments, the weighting can account for various uncertainty values for the positioning techniques in addition to the accuracy of each of the positioning techniques.

At 1528, the first mobile device 1502 can determine a position vector from the first mobile device 1502 to a second mobile device 1504, using various positioning techniques and sensor data available on the mobile devices. Both mobile devices can use GNSS receivers to determine their individual positions. Each device calculates its latitude, longitude, and altitude.

Once the individual positions are determined, the mobile devices can calculate the relative distance between them. This can be achieved by calculating the Euclidean distance in a three-dimensional coordinate system using the latitude, longitude, and altitude information of both devices.

Mobile devices often include sensors such as accelerometers, gyroscopes, and magnetometers to measure orientation. By analyzing the sensor data, each device can estimate its orientation or heading relative to the Earth's magnetic field or other reference frames.

Using the orientation information, each device can calculate the relative bearing to the other device. The bearing represents the direction from one device to another, typically measured as an angle relative to true north or another reference direction.

With the relative distance and bearing information, the mobile devices can calculate the position vector from one device to the other. The position vector consists of a magnitude (distance) and direction (bearing) and represents the displacement from one device to the other in a coordinate system.

If necessary, the position vector can be transformed into a different coordinate system, such as Cartesian (x, y, z) or a local coordinate system, based on the specific requirements of the application.

The first mobile device 1502 can determine a position arrow to the second mobile device. To determine an arrow based on a position vector, the first mobile device 1502 can use the magnitude and direction of the vector to represent the arrow's length and orientation.

The magnitude of the position vector represents the distance or displacement between two points (e.g., the position of the first mobile device 1502 and the position of the second mobile device 1504). The first mobile device 1502 can use this magnitude to determine the length of the arrow. For example, if the magnitude is larger, the first mobile device 1502 may draw a longer arrow, while a smaller magnitude can correspond to a shorter arrow.

The direction of the position vector represents the orientation or bearing from one point to another. The first mobile device 1502 can use this direction to determine the orientation of the arrow. For example, if the direction is north, the first mobile device may draw the arrow pointing upwards. Similarly, if the direction is southeast, the arrow can be drawn diagonally towards the southeast direction.

The first mobile device 1502 can consider the coordinate system or reference frame in which the position vector is defined. The first mobile device 1502 can ensure that the arrow is drawn within this coordinate system to accurately represent the direction.

At 1530, the first mobile device 1502 can use graphical tools or software to draw the directional information (e.g., a pointer or arrow) based on the determined length and orientation. This can involve using vector drawing tools or incorporating arrow symbols in the desired representation. The representation of the directional information (e.g., a pointer or arrow) may vary depending on the specific context and visualization requirements. A user may choose different styles, colors, or annotations to enhance the clarity and meaning of the directional information (e.g., a pointer or arrow) representation.

The accuracy of the directional information (e.g., a pointer or arrow) representation depends on the accuracy of the position vector calculation.

C. Modules for ordering fusion techniques

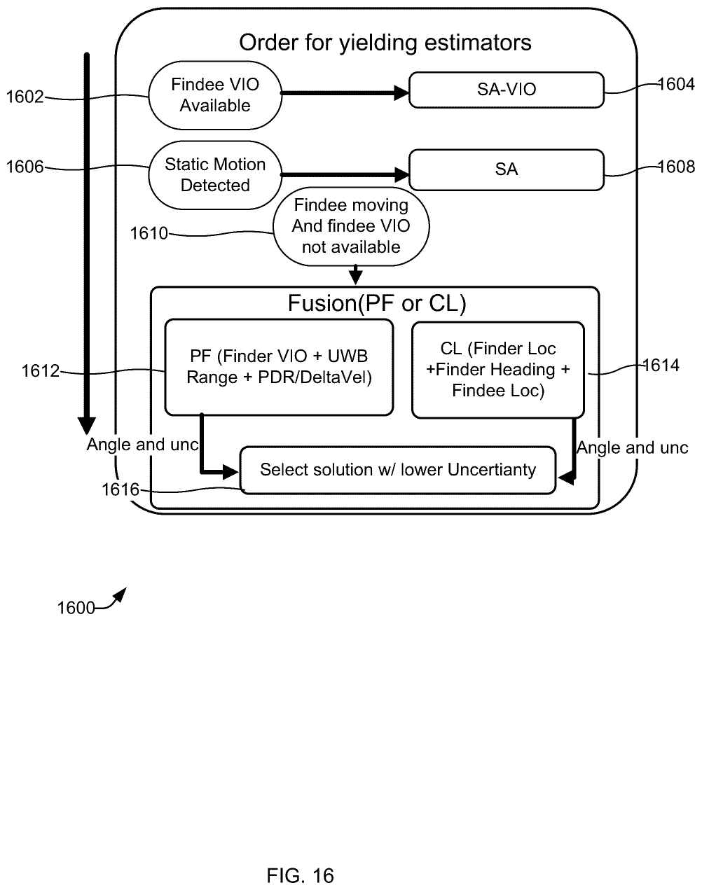

FIG. 16 illustrates a priority order or hierarchy 1600 for estimating an arrow for locating a findee device using a finder device. At 1602, the technique can determine if Visual Inertial Odometry (VIO) techniques are available for the findee device. A first priority is to use a combination of satellite and VIO techniques from both the finder device and findee device.

At 1606, the findee device can determine if the findee device is static or not moving. If the findee device is not moving satellite techniques (e.g., GNSS location techniques) can be used.

At 1610, if the findee device is moving, a fusion process can be used to determine the location of the findee device. People Finder (PF) process 1612 or core locator (CL) process 1614 can be used to determine a location of the findee device.

The PF process 1612 can be a combination of visual inertial odometry from the finder device along with ranging (e.g., UWB ranging) and pedestrian dead reckoning or delta velocity techniques. The CL process 1614 cam utilize finder device location, finder device heading and findee location. Both PF process 1612 and CL process 1614 can result in angle and uncertainty errors. At 1616, the PF process 1612 and CL process 1614 can select the solution that results in the lowest uncertainty value.

Fusion logic can be a loosely coupled solution that chooses a solution from either the location-based estimator or the particle filter e.g., UWB-based particle filter. When the solution is available from both estimators, an arrow from the estimator with the lowest uncertainty is chosen. The range value (e.g., UWB range) can be used to detect anomalies in the location solution and to determine the minimum distance below which the location-based arrow is not yielded. A hysteresis check is also implemented to minimize fluctuations if needed to bounce between a location-based arrow and a range based arrow (e.g., UWB arrow) when both solutions are available.

### D. Example Combinations of Techniques for Fusion

The following paragraphs discuss fusion of various location techniques.

1. GNSS Navigation Combined with Visual-Inertial Odometry Signals

Combining GNSS signals with visual inertial odometry (VIO) measurements can enhance the accuracy and robustness of positioning and navigation in certain scenarios, particularly when GNSS signals are degraded or unavailable. This combination is often referred to as sensor fusion or sensor integration. GNSS signals and VIO measurements can be combined as follows:

Visual inertial odometry can involve using a combination of visual sensors (such as cameras) and inertial sensors (gyroscopes and accelerometers) to estimate the device's position and orientation relative to its initial starting point. VIO techniques can provide high-rate measurements, typically at several tens or hundreds of Hz, enabling real-time tracking of motion.

Before combining the measurements, calibration between the GNSS receiver and the VIO system can be performed to align their coordinate systems and correct for any sensor biases or time offsets. The GNSS receiver and VIO system can be synchronized in terms of time. This synchronization can be achieved using techniques such as time stamping or time interpolation.

Once the GNSS and VIO measurements are appropriately calibrated and synchronized, a fusion algorithm can be employed to combine the data. Common fusion techniques include Kaman Filtering, and Particle Filters.

Kalman filters can be used for sensor fusion. Kalman filters can employ mathematical models to estimate the device's state (position, velocity, orientation) based on the measurements and their associated uncertainties. The Kalman filter can fuse GNSS and VIO measurements to provide an accurate and consistent estimate of the device's position and orientation.

Particle filters, also known as Monte Carlo localization methods, can be used for sensor fusion. Particle filters work by maintaining a set of particles that represent possible states of the system. The particles are updated and resampled based on the likelihood of the measurements from both the GNSS and VIO systems.

A fusion algorithm can assign weights or confidences to the GNSS and VIO measurements based on their reliability and accuracy. The weights can be dynamically adjusted based on the quality of the signals, the presence of signal obstructions, or the accuracy of the VIO system.

The fused output provides a more accurate and reliable estimation of the device's position, velocity, and orientation. This combined information can be used for navigation, mapping, augmented reality, or any application that requires precise localization.

Fusion of GNSS signals with VIO measurements can be a complex task, and various algorithms and techniques exist for different scenarios and requirements. Advanced techniques, such as tightly coupled integration, can further improve the fusion accuracy by considering the interdependencies between the GNSS and VIO systems.

### 2. Fusion of Local Measurements (Ranging and Odometry and GPS)

Combining wireless ranging signals, visual inertial odometry (VIO) measurements, and GNSS measurements can provide even more robust and accurate positioning and navigation solutions. This fusion of multiple sensors is commonly referred to as sensor fusion or sensor integration. These three types of measurements can be combined as follows:

Wireless ranging signals, such as those used in technologies like Wi-Fi, Bluetooth, or Ultra-Wideband (UWB), can provide distance or range measurements between the device and known reference points in the environment. These reference points can be fixed beacons or access points with known positions.

As mentioned earlier, GNSS systems provide positioning information based on satellite signals. GNSS measurements include the device's latitude, longitude, altitude, and sometimes velocity.

VIO utilizes visual sensors (e.g., cameras) and inertial sensors (e.g., gyroscopes, accelerometers) to estimate the device's position, orientation, and motion relative to its starting point.

Before fusing the measurements, calibration, and synchronization between the wireless ranging, GNSS, and VIO systems are crucial. Coordinate system alignment, sensor bias correction, and time synchronization are necessary to ensure accurate fusion.

The wireless ranging measurements, VIO estimates, and GNSS measurements need to be associated with each other. This association can involve determining which wireless ranging measurements correspond to the current VIO or GNSS measurements based on timing, proximity, or other relevant criteria.

A fusion algorithm, such as an Extended Kalman Filter (EKF) or a Particle Filter, can be employed to combine the measurements. The algorithm can consider the uncertainties and strengths of each measurement source to produce an optimized estimate of the device's state (position, velocity, orientation).

The fusion algorithm can assign weights or confidences to the measurements based on their reliability, accuracy, and the current operating conditions. The weights may be dynamically adjusted to account for the varying quality of each measurement source.

The fusion algorithm combines the wireless ranging, VIO, and GNSS measurements to generate a more accurate and robust estimation of the device's position, velocity, and orientation. The fused output can be used for navigation, localization, mapping, augmented reality applications, or any use case that requires precise positioning information.

By combining wireless ranging signals, VIO measurements, and GNSS measurements, you can leverage the strengths of each sensor type to compensate for their individual limitations. This integration enables more reliable positioning and navigation solutions, particularly in environments with challenging GNSS conditions or limited visual features for VIO.

The fusion techniques can cross check between a GNSS-based range value and a ranging value (e.g., UWB ranging) when both are available. This cross check can allow for identifying potentially inaccurate GNSS-based arrows.

For example, if a ranging value (e.g., UWB range value) is smaller than the GNSS-based distance by a significant amount, then the system should add pessimism to the GNSS-based arrow and potentially not yield it because that means that one of those two GNSS fixes could be an error, or potentially both of them

The system can generate a GNSS quality metric from a synthetic arrow based on GNSS-based locations. The GNSS quality metric can be compared with a ranging statistical metric (e.g., providing by UWB ranging). The quality metric that has the higher confidence value can statistically correct the other range value.

In various embodiments, a GNSS-based arrow can use a point of interest, corresponding to where person has been near (i.e., if odometry and ranging are unavailable). For example, if two people, a findee and a finder, and agree that they are going to meet at a defined location (e.g., Starbucks location). The Starbucks location can be stored in a map in memory. If odometry and ranging is unavailable, the finder device can rely on the location of Starbucks from the map in memory. As the finder device comes closer to the location of Starbucks the location can be used to build a better synthetic arrow because each point in the map has a corresponding global coordinate.

### 3. PDR+GNSS+VIO

Combining pedestrian dead reckoning (PDR) techniques with GNSS measurements and visual inertial odometry (VIO) measurements can provide enhanced positioning and navigation for pedestrians, especially in scenarios where GNSS signals or visual features are limited. These three types of measurements can be integrated as follows:

Pedestrian Dead Reckoning (PDR) relies on measuring and integrating step counts and orientation changes to estimate pedestrian motion. Accelerometers, gyroscopes, magnetometers, or specialized sensors, such as inertial measurement units (IMUs), can be used to capture these motion-related measurements.

GNSS systems, such as GPS, can provide absolute positioning information in outdoor environments. However, in urban areas or places with tall buildings or signal obstructions, the GNSS signals may be degraded or unavailable.

VIO combines visual sensors (e.g., cameras) and inertial sensors (e.g., accelerometers, gyroscopes) to estimate the device's motion and position relative to its starting point. VIO is effective in environments with sufficient visual features but may suffer from drift over time.

Before combining the measurements, calibration, and synchronization between the PDR, GNSS, and VIO systems are essential. Coordinate system alignment, sensor bias correction, and time synchronization ensure accurate fusion.

PDR step count and orientation changes can be associated with the corresponding time stamps of GNSS and VIO measurements. This association allows for aligning the PDR estimates with the absolute position information provided by GNSS and the relative motion information obtained from VIO.

A fusion algorithm, such as an Extended Kalman Filter (EKF), Particle Filter, or Unscented Kalman Filter (UKF), can be employed to combine the measurements. The algorithm integrates the PDR, GNSS, and VIO measurements, taking into account their uncertainties and strengths to estimate the pedestrian's position, velocity, and orientation.

The fusion algorithm assigns weights or confidences to the measurements based on their reliability, accuracy, and the current operating conditions. The weights can be dynamically adjusted to adapt to the quality of each measurement source.

The fusion algorithm combines the PDR, GNSS, and VIO measurements to produce an optimized estimation of the pedestrian's position, velocity, and orientation. The fused output provides enhanced positioning and navigation information, compensating for the limitations of individual sensors.

The integration of PDR, GNSS, and VIO measurements allows for continuous positioning and navigation, even in areas with limited GNSS availability or visual features. By fusing the complementary information from multiple sensors, the system can mitigate drift, improve accuracy, and maintain reliable positioning for pedestrian users.

Other positioning combinations can be used.

### E. Flow

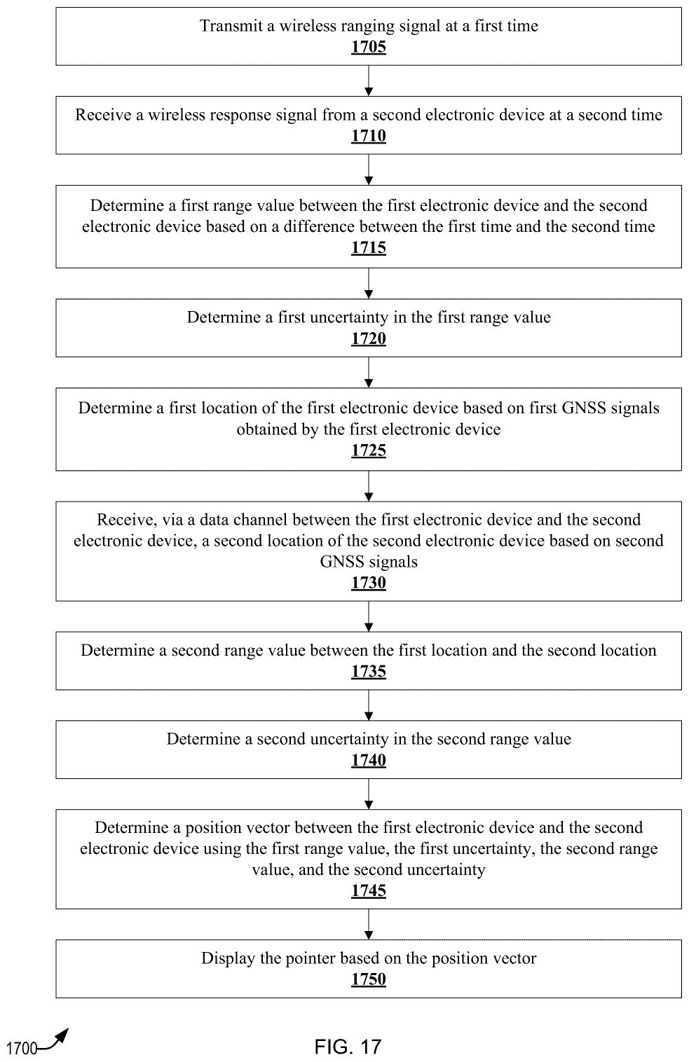

FIG. 17 is a flow chart of a process 1700 for finding a mobile device using fusion techniques, according to an example of the present disclosure. According to an example, one or more process blocks of FIG. 17 may be performed by a mobile device.

At block 1705, process 1700 may include transmitting a wireless ranging signal at a first time. The wireless ranging signal can be various wireless protocols (e.g., UWB, Bluetooth, BLE, Zigbee, Wi-Fi, etc.). The mobile device may have a wireless transmitter. For example, mobile device may transmit a wireless ranging signal at a first time, as described above.

At block 1710, process 1700 may include receiving a wireless response signal from a second mobile device at a second time. The wireless response signal may be received by one or more antenna on the mobile device. The wireless response signal may be the same wireless protocol of the wireless ranging signal. For example, device may receive a wireless response signal from a second mobile device at a second time, as described above.

At block 1715, process 1700 may include determining a first range value between the first mobile device and the second mobile device based on a difference between the first time and the second time. The wireless signal can travel at the speed of light (c). If the first mobile device (e.g., finder device) knows the transmitting time of the wireless ranging signal, the reception time of the wireless response, and a processing time for the second mobile device (e.g., the findee device), the first mobile device can calculate a range value by multiplying the time delay (e.g., reception time minus transmission time minus processing delay) by speed of light (c). For example, device may determine a first range value between the first mobile device and the second mobile device based on a difference between the first time and the second time, as described above.

At block 1720, process 1700 may include determining a first uncertainty in the first range value. For example, device may determine a first uncertainty in the first range value, as described above.

Uncertainty in a wireless ranging signal can be determined through various methods and considerations. Some approaches that can be used to assess uncertainty in a wireless ranging signal can include Measurement Error Analysis, Environmental Analysis, Signal-to-Noise Ratio Analysis, Calibration and Reference Standard analysis, and Monte Carlo Simulation.

One way to determine uncertainty is by analyzing the measurement errors associated with the ranging signal. This involves characterizing the accuracy and precision of the measurement system used for ranging. Factors such as instrument calibration, noise, interference, and signal processing algorithms can contribute to measurement errors. Statistical techniques like standard deviation or root mean square error (RMSE) can be used to quantify the uncertainty based on the measured data.

Wireless ranging signals can be influenced by environmental conditions such as multipath propagation, interference, and atmospheric effects. These factors can introduce uncertainty in the measurement. To determine uncertainty, the mobile device may need to consider the specific environment where the ranging is performed and assess the impact of these factors on the signal quality.

The SNR of the ranging signal provides a measure of the signal strength relative to the background noise. Higher SNR values generally indicate better signal quality and lower uncertainty. By evaluating the SNR, the mobile device can estimate the uncertainty in the ranging signal.

Calibration of the ranging system and the use of reference standards can help quantify uncertainty. Calibration involves comparing the measurements from the ranging system to a known reference or standard. By understanding the calibration process and associated uncertainties, the mobile device can determine the overall uncertainty in the ranging signal.

Monte Carlo simulation is a computational technique that involves running multiple simulations with randomly varied input parameters to estimate uncertainty. In the context of wireless ranging, you can use Monte Carlo simulation to model uncertainties related to factors like noise, interference, and environmental conditions. By running a large number of simulations, the mobile device can analyze the distribution of the measurement outcomes and determine the uncertainty range.

The specific method and level of uncertainty determination may depend on the ranging technology, measurement system, and the application context.

At block 1725, process 1700 may include determining a first location of the first mobile device based on first GNSS signals obtained by the first mobile device. For example, device may determine a first location of the first mobile device based on first GNSS signals obtained by the first mobile device, as described above.

At block 1730, process 1700 may include receiving, via a data channel between the first mobile device and the second mobile device, a second location of the second mobile device based on second GNSS signals. For example, device may receive, via a data channel between the first mobile device and the second mobile device, a second location of the second mobile device based on second GNSS signals, as described above.

In various embodiments, the data channel comprises a narrow band channel controlled by an ultrawideband processing chip.

At block 1735, process 1700 may include determining a second range value between the first location and the second location. For example, device may determine a second range value between the first location and the second location, as described above.

At block 1740, process 1700 may include determining a second uncertainty in the second range value. For example, device may determine a second uncertainty in the second range value, as described above.

Determining uncertainty in Global Navigation Satellite System (GNSS) position involves considering various factors that contribute to positioning errors. GNSS uncertainty can consider satellite geometry, signal quality, receiver error sources, differential positioning, error propagation and statistical analysis, and positioning solution quality indicators.

The geometry of the satellites in view affects the accuracy of GNSS positioning. Poor satellite geometry, such as satellites clustered in a small area of the sky or low elevation angles, can increase positioning uncertainty. Evaluating the Dilution of Precision (DOP) parameters, such as Position Dilution of Precision (PDOP) or Horizontal Dilution of Precision (HDOP), can provide insights into the satellite geometry and its impact on positioning uncertainty.

The quality of the GNSS signals received by the receiver is crucial. Factors such as signal strength, multipath interference, and ionospheric/tropospheric effects can introduce errors. Assessing parameters like signal-to-noise ratio (SNR), carrier-to-noise ratio (C/NO), and receiver-reported quality indicators (e.g., Signal Quality Indicator, Signal-In-Space Accuracy) can help gauge the reliability of the signals and estimate uncertainty.

GNSS receivers have inherent error sources that contribute to positioning uncertainty. These errors can include clock errors, receiver noise, multipath effects, and receiver biases. Understanding the receiver specifications and performance characteristics can assist in quantifying the uncertainty associated with these error sources.

Differential GNSS techniques involve using a reference receiver with known coordinates to improve positioning accuracy. Differential corrections can mitigate common errors, such as atmospheric delays and satellite clock errors. By utilizing differential positioning, you can reduce uncertainty in your position estimates.

Errors in individual measurements can propagate through the positioning calculations. Applying statistical analysis methods, such as error propagation techniques (e.g., root-sum-square), can help estimate the overall uncertainty in the final position solution. Understanding the statistical characteristics of the error sources, such as their standard deviations or covariance matrices, is essential for accurate error propagation.

GNSS receivers often provide indicators of the quality of the positioning solution, such as Horizontal Accuracy Estimate (HAE), Vertical Accuracy Estimate (VAE), or Estimated Position Error (EPE). These indicators offer a measure of the uncertainty in the position estimates and can be used to evaluate the reliability of the GNSS solution.

At block 1745, process 1700 may include determining a position vector between the first mobile device and the second mobile device using the first range value, the first uncertainty, the second range value, and the second uncertainty. For example, device may determine a position vector between the first mobile device and the second mobile device using the first range value, the first uncertainty, the second range value, and the second uncertainty, as described above.

In various embodiments, the first device and the second device are in motion.

At block 1750, process 1700 may include display the pointer based on the position vector. For example, device may display the pointer based on the position vector, as described above.

In various aspects, a mobile device, can include one or more processors and a memory coupled to the one or more processors. The memory can store instructions that cause the one or more processors to perform any one or more of the operations as described above

In various aspects, a non-transitory, computer readable medium can be stored instructions that when executed on one or more processors perform any one of more of the operations as described above

It should be noted that while FIG. 17 shows example blocks of process 1700, in some implementations, process 1700 may include additional blocks, fewer blocks, different blocks, or differently arranged blocks than those depicted in FIG. 17. Additionally, or alternatively, two or more of the blocks of process 1700 may be performed in parallel.

### VI. Efficient Transfer Between Devices

Mobile devices can transmit information between the devices using wireless signals. The larger the information, the more bandwidth that is needed to transfer the information. The following technique described geodetic displacement techniques for use by one mobile device to find a second mobile device. The geodetic displacement techniques can result in an efficient transfer of information between the device.

A. Grid with reference points and offsets

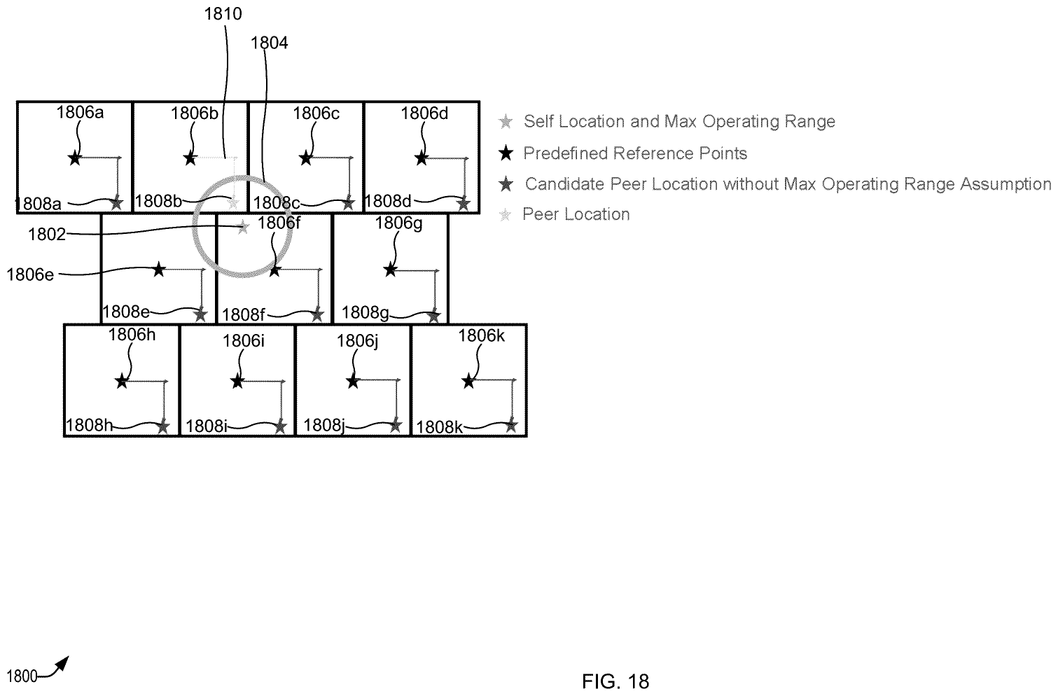

FIG. 18 illustrates an exemplary layout for geodetic displacement techniques. Geodetic displacement is a positioning technique that involves calculating the coordinates of a point based on its displacement from a known reference point in a geodetic coordinate system.

This technique can start by establishing one or more reference points with known coordinates using a reliable positioning method such as GNSS (Global Navigation Satellite System) or surveying techniques. The reference points can serve as the origin for the geodetic displacement calculations.

The technique can include determining the displacement vector between the reference point(s) and the target point for the location of the second mobile device. The displacement vector can consist of the differences in latitude, longitude, and possibly altitude (if applicable) between the reference point and the target point.

The techniques can use a geodetic coordinate system, such as the World Geodetic System (WGS84) or a specific local geodetic datum. These coordinate systems can account for the Earth's curved surface and provide accurate representations of points on the Earth.

The technique can use the geodetic displacement vector, add, or subtract the displacement values from the reference point's coordinates to determine the coordinates of the target point. The latitude and longitude coordinates are updated based on the displacement values, and if applicable, the altitude can also be adjusted.

The accuracy of the positioning technique using geodetic displacement depends on the accuracy of the reference point's coordinates and the accuracy of the displacement vector measurements. The reliability of the geodetic coordinate system used is also crucial for accurate positioning.

The techniques can account for any errors or uncertainties associated with the displacement vector measurements or the reference point's coordinates. Proper error estimation and propagation techniques can be applied to assess the overall uncertainty in the determined position.

This positioning technique using geodetic displacement can be commonly used in applications where the displacement between two points is known or measured, such as surveying, geodesy, and geodetic control network establishment. It provides a way to determine the position of a target point relative to a known reference point in a geodetic coordinate system.

FIG. 18 illustrates a location 1802 of the first mobile device. FIG. 18 illustrates a maximum operational range 1804 of the location techniques. FIG. 18 illustrates various predefined reference points 1806 (identified as 1806a, 1806b, 1806c, 1806d, 1806e, 1806f, 1806g, 1806h, 1806i, 1806j, 1806k).

As discussed above a candidate peer location 1808 for the second mobile device can be a set distance relative to the predefined reference points 1806. Several candidate peer locations 1808 are illustrated as 1808a, 1808b, 1808c, 1808d, 1808e, 1808f, 1808g, 1808h, 1808i, 1808j, 1808k. As shown in FIG. 18, each of the candidate peer location 1808 is a set distance relative to the predefined reference points.

The techniques can use the maximum operational range 1804 in determining which of the candidate peer locations 1808 is the accurate position of the second mobile device. Only candidate peer location 1808b is within the maximum operational range 1804. Therefore, the mobile device can select candidate peer location 1808b as the location of the second mobile device. The position of the second mobile device can be represented as a simple offset 1810 from predefined reference point 1806b. This simple offset 1810 can be transmitted to the first mobile device to determine the location of the second mobile device.

B. Sequence diagram for communicating position information

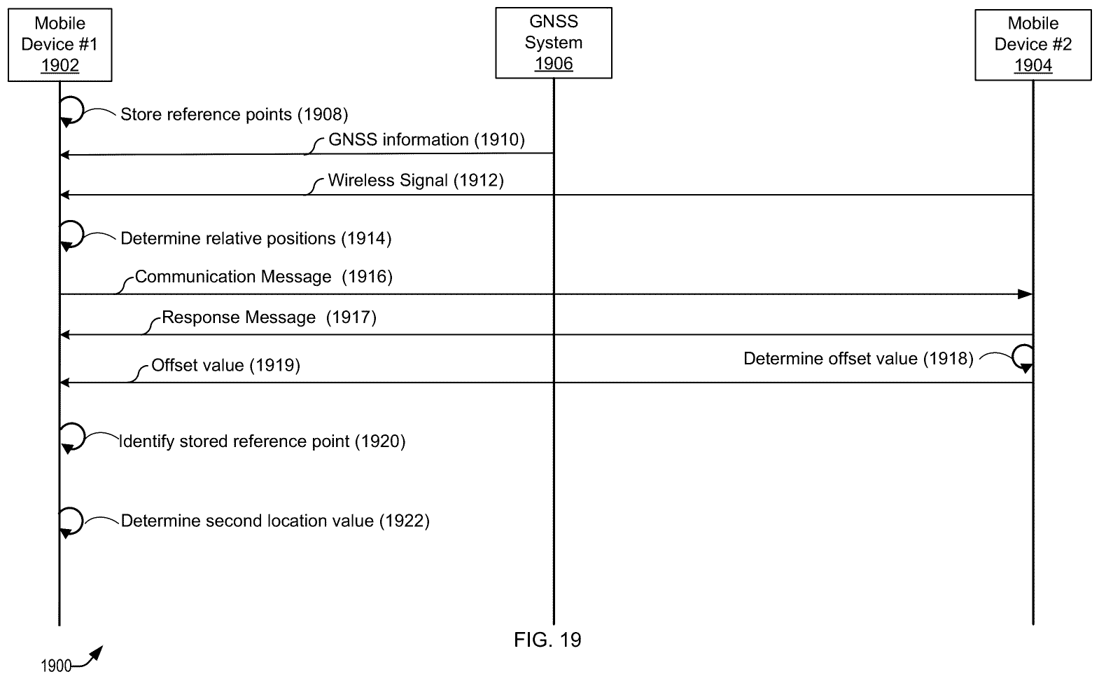

FIG. 19 illustrates a cross-functional flowchart 1900 for efficient position transfer between a first mobile device 1902 and a second mobile device 1904. A GNSS system 1906 can provide positioning information as described above.

At 1908, the first mobile device 1902 can store a plurality of reference points in a memory of the first mobile device 1902. The first mobile device 1902 can store a grid of reference points of a global reference frame. In various embodiments, the second mobile device 1902 can store a plurality of reference points in a memory of the second mobile device 1904.

At 1910, the first mobile device 1902 can receive GNSS information. The first mobile device 1902 can determine the first location of the first mobile device within the global reference frame using the measurements made by the first mobile device 1902.

At 1912, the first mobile device 1902, can determine a wireless signal transmitted from the second mobile device 1904. The first mobile device can determine a relative position between the first mobile device 1902 and the second mobile device 1904 based on the wireless signal 1912. For example, the wireless signal can be a UWB signal and the first wireless device can determine a range to the second wireless device via UWB ranging. In various embodiments, the wireless signal can include odometry information from the second wireless device.

At 1914, the first mobile device can determine the relative position of the second wireless device. In various embodiments, the relative position of the second wireless device can be determined by analyzing the direction or angle at which a wireless signal arrives at multiple antennas or sensor arrays on a device, it is possible to estimate the relative position. Angle of arrival techniques can typically require an array of antennas or multiple sensors to accurately determine the angle of the incoming signal.

The first mobile device 1902 can establish a wireless communication channel between the first mobile device and the second mobile device. To establish a communication channel, wireless transceivers (e.g., Wi-Fi, Bluetooth, UWB) can synchronize their timing and carrier frequency. In various embodiments, the communication channel can be one of Bluetooth, Zigbee, or peer-to-peer Wi-Fi. Synchronization ensures that both the transmitter and receiver are operating on the same time scale and frequency reference. Common synchronization techniques include Time Division Multiple Access (TDMA) or the use of preamble sequences for timing and frequency synchronization.

The wireless transceiver can perform an initialization process to set up the communication channel parameters. This process can include exchanging control information, such as channel settings, power levels, modulation scheme, and synchronization parameters, between the communicating devices. Initialization ensures that both devices are configured to communicate with each other.

At 1916, the first mobile device 1902 can transmit a communication message to the second mobile device 1904. The second mobile device 1904 can receive the communication message. The second mobile device can transmit a response message. The response message can include control information for the second mobile device 1904.

At 1917, the first mobile device can receive the response message.

Wireless transceivers estimate the characteristics of the communication channel to account for signal propagation effects and multipath interference. Channel estimation involves analyzing the received signal and estimating channel parameters such as path delays, amplitudes, and phase shifts. This information is crucial for efficient data transmission and reception.

Once the communication channel is established, wireless transceivers can transmit data using the chosen modulation scheme. Data is encoded onto the wireless pulses, and the modulated pulses are transmitted over the air.

The wireless transceiver on the receiving end demodulates and decodes the received wireless pulses to recover the transmitted data. The receiver performs the inverse process of the transmitter, extracting the information from the received signal using synchronization, demodulation, and decoding techniques.

Wireless transceivers can employ error correction coding techniques to enhance the reliability of data transmission. Error correction codes add redundancy to the transmitted data, allowing the receiver to detect and correct errors introduced during transmission.

At 1918, the second mobile device 1904 can determine an offset value between a reference point and its position in the global reference frame. The offset value can be stored in a memory of the second mobile device 1904. The offset value can be transmitted to the first mobile device using the wireless channel. The offset value may only be a few bytes as an offset from a latitude and longitude from a selected reference point. The offset value can be measured by the second mobile device 1904.

At 1919, the first mobile device 1902 can receive the offset value via the wireless channel.

At 1920, the first mobile device 1902 can identify a stored reference point of the grid of reference points corresponding to the first reference point based on the first location of the first mobile device 1902, the relative position between the first mobile device 1902 and the second mobile device 1904, and the offset value.

At 1922, the first mobile device 1902 can determine a second location of the second mobile device 1904 based on the stored reference point, wherein the reference points are separated by at least a first threshold distance. The first threshold distance can be less than the offset value.

The first mobile device can store the second location in a memory of the second mobile device 1902.

In some embodiments, the mobile device can formulate the way of sending the data that takes into account that the findee device can only be certain places based on the fact that these two devices are communicating with each other. Once a wireless signal is detected between the two devices, this technique can be used. This technique can reduce the size (e.g., number of bytes) that the information file requires. In various embodiments, it may only use approximately 16 bytes to get the location information. In various embodiments this location information can be reduced to around three bytes because of the bandwidth constraints.

Using this technique a global reference frame can be stored or generated on all devices, including the two devices in question. A set of grids is defined throughout the world, e.g., with 1,000 meter accuracy, but could be accurate as 50 meters. An offset (e.g., a latitude, a longitude) can be defined relative to the grid. The devices do not know the original grid point, but after a few measurements it is clear that only one original grid point may be possible. In this way the offset can be defined in as few bytes as possible. The offset for the second mobile device can be generated and transferred to the first wireless device. The offset can be communicated through a data channel.

### C. Method for Efficient Transfer of Position Information

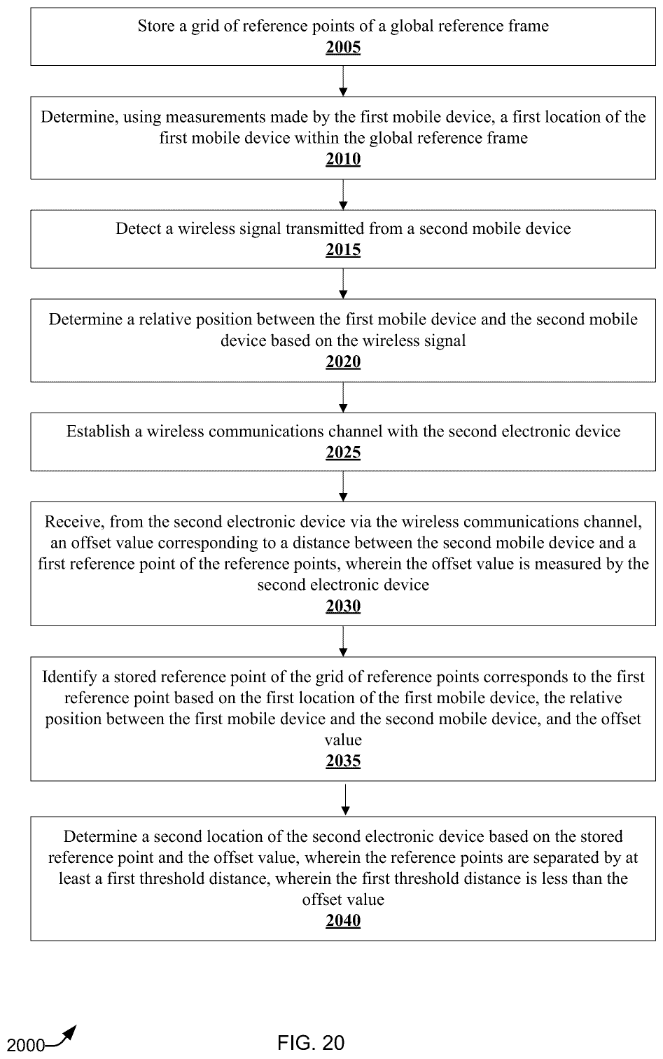

FIG. 20 is a flow chart of a process 2000 for efficient transfer of position information, according to an example of the present disclosure. According to an example, one or more process blocks of FIG. 20 may be performed by a mobile device.

At block 2005, process 2000 may include storing a grid of reference points of a global reference frame. The grid reference frame can be stored in a memory of each mobile device. For example, the mobile device may store a grid of reference points of a global reference frame, as described above.

At block 2010, process 2000 may include determining, using measurements made by the first mobile device, a first location of the first mobile device within the global reference frame. In various embodiments, the measurement can be determine using any one of a number of positioning techniques (e.g., GNSS, ranging, RSSI, VIO, PDR, RFID, etc.). The first location of the first mobile device can be stored in a memory of the mobile device. For example, the mobile device may determine, using measurements made by the first mobile device, a first location of the first mobile device within the global reference frame, as described above.

At block 2015, process 2000 may include detecting a wireless signal transmitted from a second mobile device. The wireless signal indicates that the two devices are local to each other, and thus can share other kinds of position information besides a GNSS position. The wireless signal can be any one of various wireless signal protocol (e.g., Bluetooth, BLE, Wi-Fi, UWB, Zigbee, etc.) For example, device may detect a wireless signal transmitted from a second mobile device, as described above. The wireless signal can also provide position information e.g., ranging information such as for signal strength or time of flight.

At block 2020, process 2000 may include determining a relative position between the first mobile device and the second mobile device based on the wireless signal. For example, device may determine a relative position between the first mobile device and the second mobile device based on the wireless signal, as described above. For instance, the relative position can be determined using ranging or odometry information.

Determining bearing or direction based on wireless signals can typically involve using signal strength or signal propagation characteristics. These techniques can include RSSI, multiple antenna arrays, magnetic field sensors, and angle of arrival techniques.

Mobile devices can measure the strength of a wireless signal from a known source. By comparing the RSSI values from multiple sources or antennas, the device can estimate the relative direction or bearing. This technique is commonly used in Wi-Fi-based indoor positioning systems.

Some mobile devices are equipped with multiple antennas or antenna arrays. By analyzing the signal strength or phase differences between the antennas, the device can determine the direction of arrival (DOA) of the wireless signal. This technique is utilized in beamforming and direction finding applications.

Some mobile devices have built-in magnetic field sensors, such as magnetometers. These sensors can detect changes in the Earth's magnetic field caused by nearby wireless signals. By analyzing the magnetic field variations, the device can estimate the direction or bearing of the signal source.

Angle of Arrival (AoA) techniques involve using multiple antennas or antenna arrays to measure the angle at which a wireless signal arrives. By analyzing the phase differences or time delays between the antennas, the mobile device can estimate the direction or bearing of the signal source.

At block 2025, process 2000 may include establishing a wireless communications channel with the second mobile device. For example, device may establish a wireless communications channel with the second mobile device, as described above.

Ultra-Wideband (UWB) chips use a specific set of protocols and techniques to open a communication channel. UWB chips can establish a communication channel as follows:

UWB chips typically operate in a frequency range of several GHz and use extremely short-duration pulses. When two UWB devices want to establish a communication channel, they start by performing a process called channel setup. During this process, the devices exchange necessary information to synchronize their timing and frequency characteristics.

UWB chips excel in accurate ranging and localization capabilities. Once the channel setup is complete, the UWB devices can exchange ranging information. This information includes precise timestamps and measurements of the time it takes for UWB pulses to travel between the devices. By analyzing the time-of-flight of these pulses, the devices can calculate the distance or range between them.

After ranging and localization, the UWB devices can proceed to transmit data over the established communication channel. UWB chips can transmit data at high data rates due to their wide bandwidth. The communication can involve various types of data, such as voice, audio, video, or sensor data.

UWB chips can also incorporate security features to ensure secure communication. Encryption algorithms and authentication protocols can be implemented to protect the transmitted data from unauthorized access or tampering.

In various embodiments, the communication channel can be Bluetooth, peer to peer wifi, or maybe cellular if available.

At block 2030, process 2000 may include receiving, from the second mobile device via the wireless communications channel, an offset value corresponding to a distance between the second mobile device and a first reference point of the reference points, where the offset value is measured by the second mobile device. For example, device may receive, from the second mobile device via the wireless communications channel, an offset value corresponding to a distance between the second mobile device and a first reference point of the reference points, where the offset value is measured by the second mobile device, as described above.

At block 2035, process 2000 may include identifying a stored reference point of the grid of reference points corresponds to the first reference point based on the first location of the first mobile device, the relative position between the first mobile device and the second mobile device, and the offset value. For example, device may identify a stored reference point of the grid of reference points corresponds to the first reference point based on the first location of the first mobile device, the relative position between the first mobile device and the second mobile device, and the offset value, as described above.

In order to calculate the offset value between two location reference frames, the mobile device may use information about the coordinates or positions of at least three common points in both reference frames. These common points are known as control points or tie points. The process typically involves the following steps:

First, the process can identify at least three common points with known coordinates in both reference frames. These points should be easily identifiable and distinguishable in both reference frames.

Second the process can obtain the coordinates of the common points in each reference frame. The coordinates can be in any suitable coordinate system, such as latitude and longitude, Cartesian coordinates, or any other geodetic system.

Third, the process can use an appropriate transformation method or algorithm to convert the coordinates of the common points from one reference frame to the other. This transformation accounts for the differences in orientation, scale, and translation between the two frames.

Once you have transformed the coordinates of the common points, calculate the differences or offsets between the corresponding points in the two reference frames. This can be done by subtracting the transformed coordinates of the points in one frame from the coordinates in the other frame.

The process can compute the average offset value by taking the mean of the calculated offsets for all the common points. This provides a single value that represents the overall offset between the two reference frames.

The specific transformation method or algorithm used for calculating the offset may vary depending on the characteristics of the reference frames, such as their spatial relationship, coordinate systems, and any known geometric transformations. In some cases, more advanced techniques like least squares adjustment or geodetic datum transformation models may be required for accurate results.

At block 2040, process 2000 may include determining a second location of the second mobile device based on the stored reference point and the offset value. For example, device may determine a second location of the second mobile device based on the stored reference point and the offset value, as described above.

Process 2000 may include additional implementations, such as any single implementation or any combination of implementations described below and/or in connection with one or more other processes described elsewhere herein. In a first implementation, the reference points are separated by at least a first threshold distance, where the first threshold distance is less than the offset value.

In various embodiments, the grid coordinates are less than 5 bytes.

It should be noted that while FIG. 20 shows example blocks of process 2000, in some implementations, process 2000 may include additional blocks, fewer blocks, different blocks, or differently arranged blocks than those depicted in FIG. 20. Additionally, or alternatively, two or more of the blocks of process 2000 may be performed in parallel.

### VII. Other Techniques

A. Signaling Method to Indicate when Coordinate System is Reset

A reset might be needed when a person with a finder mobile device covers the camera or stops walking. A measure displacement structure can be defines having an enter timestamp, which indicates that after this time, all the data that the mobile device receives can be used together. An applicability timestamp is the actual time of that particular data that is coming in when that horizontal displacement or vertical displacement is applicable, where it can be used. Based on the enter timestamp being reset or moved, the device knows that some of the old data is not usable anymore. If packets are lost between two packets, the mobile device can still look at two packets that we received and determine the velocity changed by this much between these two, as long as there has not been a reset.

### B. Change Arrow Based on Staleness of Data

Over time the data for GNSS-based positioning arrow can become stale. Rather than no longer computing a GNSS-based arrow when that happens, the mobile device can be smart and still use the stale findee location that the mobile device received a few second ago, or even up to tens of seconds.

In various embodiments, the mobile device can slowly inflate illustrate and inflate an uncertainty bubble around the findee location. The uncertainty bubble can be a function of two things; one, the amount of time it has been since that findee location has last been updated to us, and two, as a function of the knowledge that we have on the findee motion.

An uncertainty bubble, also known as an error ellipse or accuracy circle, is a graphical representation of the positional uncertainty associated with a GNSS-based arrow or any location determined using Global Navigation Satellite Systems (GNSS). It can provide an indication of the potential error or uncertainty in the arrow's position. The uncertainty bubble can work as follows:

First, GNSS receivers collect signals from multiple satellites in order to calculate the receiver's position. These signals are subject to various sources of error, including atmospheric conditions, satellite geometry, clock inaccuracies, and multipath interference.

Second, the GNSS receiver processes the received signals and calculates its position using techniques like trilateration or multilateration. The receiver estimates its position based on the distances to the visible satellites and the known positions of those satellites.

Third, during the position calculation process, the GNSS receiver also estimates the uncertainties or errors associated with its position. These errors can include horizontal and vertical errors, along with other metrics such as dilution of precision (DOP) values.

Fourth, the uncertainty or error estimates are typically represented as an uncertainty bubble or ellipse around the calculated position. The size and shape of the bubble indicate the expected positional uncertainty. For example, a larger bubble represents a higher degree of uncertainty, while a smaller bubble indicates higher confidence in the calculated position.

The uncertainty bubble is often associated with a confidence level, such as a 95% confidence level. This means that the true position is expected to lie within the uncertainty bubble with a 95% probability. The confidence level can be adjusted based on specific requirements or standards.

The accuracy and size of the uncertainty bubble can vary based on several factors, including the quality of GNSS signals, satellite geometry, receiver quality, environmental conditions, and the presence of obstructions. Additionally, post-processing techniques or differential GNSS methods can be employed to further improve the accuracy and reduce the size of the uncertainty bubble.

If the uncertainty becomes large enough, the GNSS-arrow will stop being yielded.

### VIII. Ranging

In some embodiments, a mobile device can include circuitry for performing ranging measurements. Such circuitry can include one or more dedicated antennas (e.g., 3) and circuitry for processing measured signals. The ranging measurements can be performed using the time-of-flight of pulses between the two mobile devices. In some implementations, a round-trip time (RTT) is used to determine distance information, e.g., for each of the antennas. In other implementations, a single-trip time in one direction can be used. The pulses may be formed using ultra-wideband (UWB) radio technology.

### A. Sequence Diagram

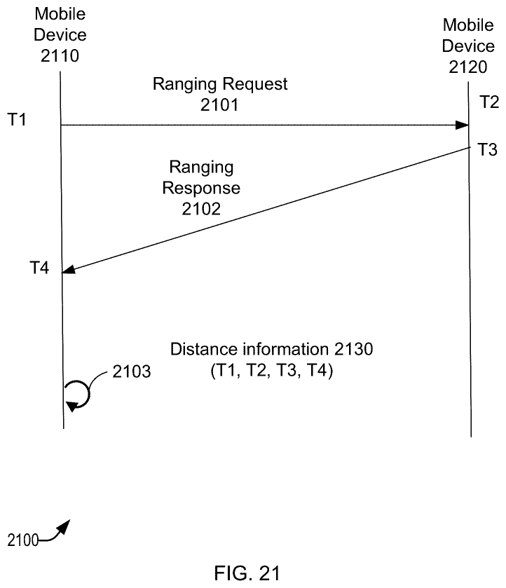

FIG. 21 shows a sequence diagram 2100 for performing a ranging measurement between two mobile devices according to embodiments of the present disclosure. The two mobile devices may belong to two different users. The two users may know each other, and thus have each other's phone numbers or other identifiers. As described in more detail later, such an identifier can be used for authentication purposes, e.g., so ranging is not performed with unknown devices. Although FIG. 21 shows a single measurement, the process can be repeated to perform multiple measurements over a time interval as part of a ranging session, where such measurements can be averaged or otherwise analyzed to provide a single distance value, e.g., for each antenna.

A first mobile device 2110 (e.g., a smartphone) can initiate a ranging measurement (operation) by transmitting a ranging request 2101 to a second mobile device 2120. Ranging request 2101 can include a first set of one or more pulses. The ranging measurement can be performed using a ranging wireless protocol (e.g., UWB). The ranging measurement may be triggered in various ways, e.g., based on user input and/or authentication using another wireless protocol, e.g., Bluetooth low energy (BLE).

At T₁, the first mobile device 2110 transmits ranging request 2101. At T₂, the second mobile device 2120 receives ranging request 2101. T₂ can be an average received time when multiple pulses are in the first set. The second mobile device 2120 can be expecting the ranging request 2101 within a time window based on previous communications, e.g., using another wireless protocol. The ranging wireless protocol and another wireless protocol can be synchronized so that mobile device 2120 can turn on the ranging antenna(s) and associated circuitry for a specified time window, as opposed to leaving them on for an entire ranging session.

In response to receiving the ranging request 2101, mobile device 2120 can transmit ranging response 2102. As shown, ranging response 2102 is transmitted at time T₃, e.g., a transmitted time of a pulse or an average transmission time for a set of pulses. T₂ and T₃ may also be a set of times for respective pulses. Ranging response 2102 can include times T₂ and T₃ so that mobile device 2110 can compute distance information. As an alternative, a delta between the two times (e.g., T₃-T₂) can be sent. The ranging response 2102 can also include an identifier for the first mobile device 2110, an identifier for the second mobile device 2120, or both.

At T₄, the first mobile device 2110 can receive ranging response 2102. Like the other times, T₄ can be a single time value or a set of time values.

At 2103, the first mobile device 2110 computes distance information 2130, which can have various units, such as distance units (e.g., meters) or as a time (e.g., milliseconds). Time can be equivalent to a distance with a proportionality factor corresponding to the speed of light. In some embodiments, a distance can be computed from a total round-trip time, which may equal T₂-T₁+T₄-T₃. In some embodiments, the processing time for the second mobile device 2120 can also be subtracted from the total round-trip time. More complex calculations can also be used, e.g., when the times correspond to sets of times for sets of pulses and when a frequency correction is implemented.

### B. Triangulation

In some embodiments, a mobile device can have multiple antennas, e.g., to perform triangulation. The separate measurements from different antennas can be used to determine a two-dimensional (2D) position, as opposed to a single distance value that could result from anywhere on a circle/sphere around the mobile device. The two-dimensional (2D) position can be specified in various coordinates, e.g., Cartesian, or polar, where polar coordinates can comprise an angular value and a radial value.

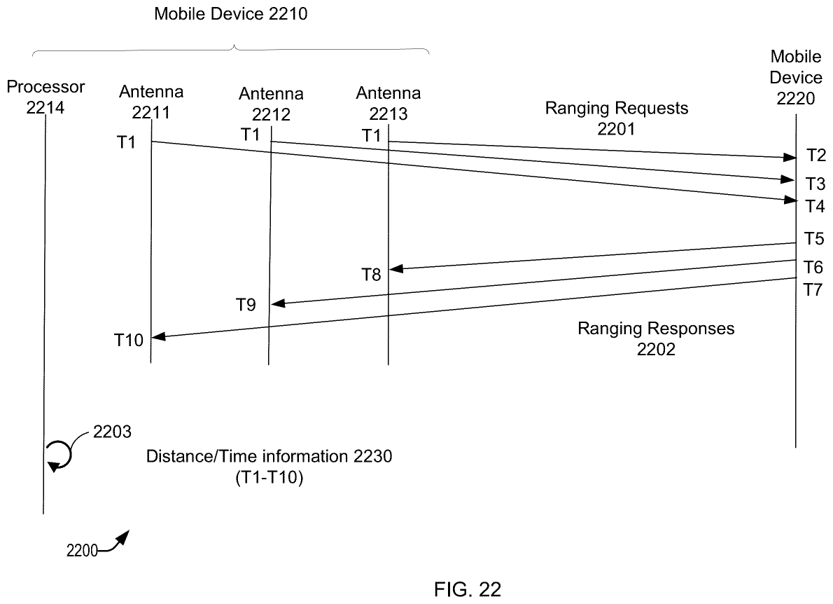

FIG. 22 shows a sequence diagram 2200 of a ranging operation involving a mobile device 2210 having three antennas 2211, 2212, and 2213 according to embodiments of the present disclosure. Antennas 2211, 2212, 2213 can be arranged to have different orientations, e.g., to define a field of view for performing ranging measurements.

In this example of FIG. 22, each of antennas 2211, 2212, 2213 transmits a packet (including one or more pulses) that is received by mobile device 2220. These packets can be part of ranging requests 2201. The packets can each be transmitted at time T1, although they can be transmitted at different times in other implementations.

In some embodiments, mobile device 2220 can have multiple antennas itself. In such an implementation, an antenna of mobile device 2210 can send a packet to a particular antenna (as opposed to a broadcast) of mobile device 2220, which can respond to that particular packet. Mobile device 2220 can listen at a specified antenna so that both devices know which antennas are involved, or a packet can indicate which antenna a message is for. For example, a first antenna can respond to a received packet; and once the response is received, another packet can be sent to a different antenna. Such an alternative procedure may take more time and power.

The three packets of ranging requests 2201 are received at times T₂, T₃, and T₄, respectively. Thus, the antenna(s) (e.g., UWB antennas) of mobile device 2220 can listen at substantially the same time and respond independently. Mobile device 2220 provides ranging responses 2202, which are sent at times T₅, T₆, and T₇, respectively. Mobile device 2210 receives the ranging responses at times T₈, T₉, and T₁₀, respectively.

At 2203, processor 2214 of mobile device 2210 computes distance information 2230, e.g., as described herein. Processor 2214 can receive the times from the antennas and more specifically from circuitry (e.g., UWB circuitry), that analyzes signals from antennas 2211, 2212, 2213. As described later, processor 2214 can be an always-on processor that uses less power than an application processor that can perform functionality that is more general. Distance information 2230 can be used to determine a two dimensional (2D) or three dimensional (3D) position of mobile device 2220, where such position can be used to configure a display screen of mobile device 2210. For instance, the position can be used to determine where to display an icon corresponding to mobile device 2220, e.g., which position in a list, which position in a 2D grid, or in which cluster of 1D, 2D, or 3D distance/position ranges to display the icon.

In some embodiments, to determine which ranging response is from which antenna, mobile device 2220 can inform mobile device 2210 of the order of response messages that are to be sent, e.g., during a ranging setup handshake, which may occur using another wireless protocol. In other embodiments, the ranging responses can include identifiers, which indicate which antenna sent the message. These identifiers can be negotiated in a ranging setup handshake.

Messages in ranging requests 2201 and ranging responses 2202 can include very little data in the payload, e.g., by including few pulses. Using few pulses can be advantageous. The environment of a mobile device (potentially in a pocket) can make measurements difficult. As another example, an antenna of one device might face a different direction than the direction from which the other device is approaching. Thus, it is desirable to use high power for each pulse, but there are government restrictions (as well as battery concerns) on how much power can be used within a specified time window (e.g., averaged over one millisecond). The packet frames in these messages can be about 150 to 190 microseconds long.

### C. UWB

The wireless protocol used for ranging can have a narrower pulse (e.g., a narrower full width at half maximum (FWHM)) than a first wireless protocol (e.g., Bluetooth) used for initial authentication or communication of ranging settings. In some implementations, the ranging wireless protocol (e.g., UWB) can provide distance accuracy of 5 cm or better. In various embodiments, the frequency range can be between 3.1 to 10.6 Gigahertz (GHz). Multiple channels can be used, e.g., one channel at 6.5 GHz another channel at 8 GHz. Thus, in some instances, the ranging wireless protocol does not overlap with the frequency range of the first wireless protocol (e.g., 2.4 to 2.485 GHz).

The ranging wireless protocol can be specified by IEEE 802.15.4, which is a type of UWB. Each pulse in a pulse based UWB system can occupy the entire UWB bandwidth (e.g., 500 MHZ), thereby allowing the pulse to be localized in time (i.e., narrow width in time, e.g., 0.5 ns to a few nanoseconds). In terms of distance, pulses can be less than 60 cm wide for a 500 MHz-wide pulse and less than 23 cm for a 1.3 GHZ-bandwidth pulse. Because the bandwidth is so wide and width in real space is so narrow, very precise time-of-flight measurements can be obtained.

Each one of ranging messages (also referred to as frames or packets) can include a sequence of pulses, which can represent information that is modulated. Each data symbol in a frame can be a sequence. The packets can have a preamble that includes header information, e.g., of a physical layer and a media access control (MAC) layer and may include a destination address. In some implementations, a packet frame can include a synchronization part and a start frame delimiter, which can line up timing.

A packet can include how security is configured and include encrypted information, e.g., an identifier of which antenna sent the packet. The encrypted information can be used for further authentication. However, for a ranging operation, the content of the data may not need to be determined. In some embodiments, a timestamp for a pulse of a particular piece of data can be used to track a difference between transmission and reception. Content (e.g., decrypted content) can be used to match pulses so that the correct differences in times can be computed. In some implementations, the encrypted information can include an indicator that authenticates which stage the message corresponds, e.g., ranging requests 2201 can correspond to stage 1 and ranging responses 2202 can correspond to stage 2. Such use of an indicator may be helpful when more than two devices are performing ranging operations in near each other.

The narrow pulses (e.g., ˜one nanosecond width) can be used to accurately determine a distance. The high bandwidth (e.g., 500 MHz of spectrum) allows the narrow pulse and accurate location determination. A cross correlation of the pulses can provide a timing accuracy that is a small fraction of the width of a pulse, e.g., providing accuracy within hundreds or tens of picoseconds, which provides a sub-meter level of ranging accuracy. The pulses can represent a ranging waveform of plus 1's and minus 1's in some pattern that is recognized by a receiver. The distance measurement can use a round trip time measurement, also referred to as a time-of-flight measurement. As described above, the mobile device can send a set of timestamps, which can remove a necessity of clock synchronization between the two devices.

### IX. UWB Device

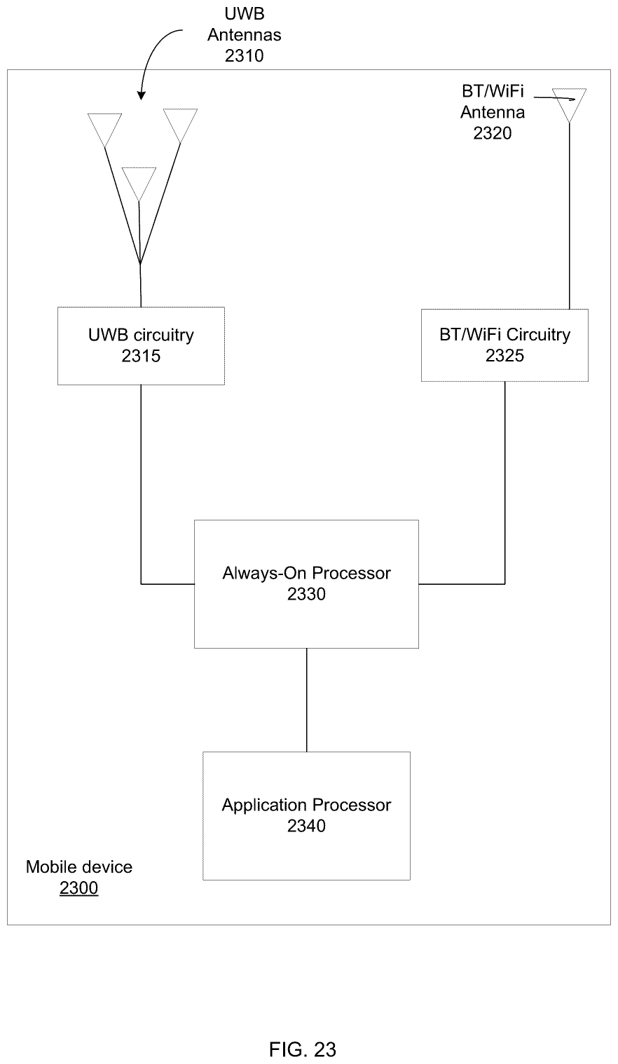

FIG. 23 is a block diagram of components of a mobile device 2300 operable to perform ranging according to embodiments of the present disclosure. Mobile device 2300 includes antennas for at least two different wireless protocols, as described above. The first wireless protocol (e.g., Bluetooth) may be used for authentication and exchanging ranging settings. The second wireless protocol (e.g., UWB) may be used for performing ranging with another mobile device.

As shown, mobile device 2300 includes UWB antennas 2310 for performing ranging. UWB antennas 2310 are connected to UWB circuitry 2315 for analyzing detected signals from UWB antennas 2310. In some embodiments, mobile device 2300 includes three or more UWB antennas, e.g., for performing triangulation. The different UWB antennas can have different orientations, e.g., two in one direction and a third in another direction. The orientations of the UWB antennas can define a field of view for ranging. As an example, the field of view can span 120 degrees. Such regulation can allow a determination of which direction a user is pointing a device relative to one or more other nearby devices. The field of view may include any one or more of pitch, yaw, or roll angles.

UWB circuitry 2315 can communicate with an always-on processor (AOP) 2330, which can perform further processing using information from UWB messages. For example, AOP 2330 can perform the ranging calculations using timing data provided by UWB circuitry 2315. AOP 2330 and other circuits of the device can include dedicated circuitry and/or configurable circuitry, e.g., via firmware or other software.

As shown, mobile device 2300 also includes Bluetooth (BT)/Wi-Fi antenna 2320 for communicating data with other devices. Bluetooth (BT)/Wi-Fi antenna 2320 is connected to BT/Wi-Fi circuitry 2325 for analyzing detected signals from BT/Wi-Fi antenna 2320. For example, BT/Wi-Fi circuitry 2325 can parse messages to obtain data (e.g., an authentication tag), which can be sent on to AOP 2330. In some embodiments, AOP 2330 can perform authentication using an authentication tag. Thus, AOP 2330 can store or retrieve a list of authentication tags for which to compare a received tag against, as part of an authentication process. In some implementations, such functionality could be achieved by BT/Wi-Fi circuitry 2325.

In other embodiments, UWB circuitry 2315 and BT/Wi-Fi circuitry 2325 can alternatively or in addition be connected to application processor 2340, which can perform similar functionality as AOP 2330. Application processor 2340 typically requires more power than AOP 2330, and thus power can be saved by AOP 2330 handling certain functionality, so that application processor 2340 can remain in a sleep state, e.g., an off state. As an example, application processor 2340 can be used for communicating audio or video using BT/Wi-Fi, while AOP 2330 can coordinate transmission of such content and communication between UWB circuitry 2315 and BT/Wi-Fi circuitry 2325. For instance, AOP 2330 can coordinate timing of UWB messages relative to BT advertisements.

Coordination by AOP 2330 can have various benefits. For example, a first user of a sending device may want share content with another user, and thus ranging may be desired with a receiving device of this other user. However, if many people are in the same room, the sending device may need to distinguish a particular device among the multiple devices in the room, and potentially determine which device the sending device is pointing to. Such functionality can be provided by AOP 2330. In addition, it is not desirable to wake up the application processor of every other device in the room, and thus the AOPs of the other devices can perform some processing of the messages and determine that the destination address is for a different device.

To perform ranging, BT/Wi-Fi circuitry 2325 can analyze an advertisement signal from another device to determine that the other device wants to perform ranging, e.g., as part of a process for sharing content. BT/Wi-Fi circuitry 2325 can communicate this notification to AOP 2330, which can schedule UWB circuitry 2315 to be ready to detect UWB messages from the other device.

For the device initiating ranging, its AOP can perform the ranging calculations. Further, the AOP can monitor changes in distance between the other devices. For example, AOP 2330 can compare the distance to a threshold value and provide an alert when the distance exceeds a threshold, or potentially provide a reminder when the two devices become sufficiently close. An example of the former might be when a parent wants to be alerted when a child (and presumably the child's device) is too far away. An example of the latter might be when a person wants to be reminded to bring up something when talking to a user of the other device. Such monitoring by the AOP can reduce power consumption by the application processor.

### X. Example Device

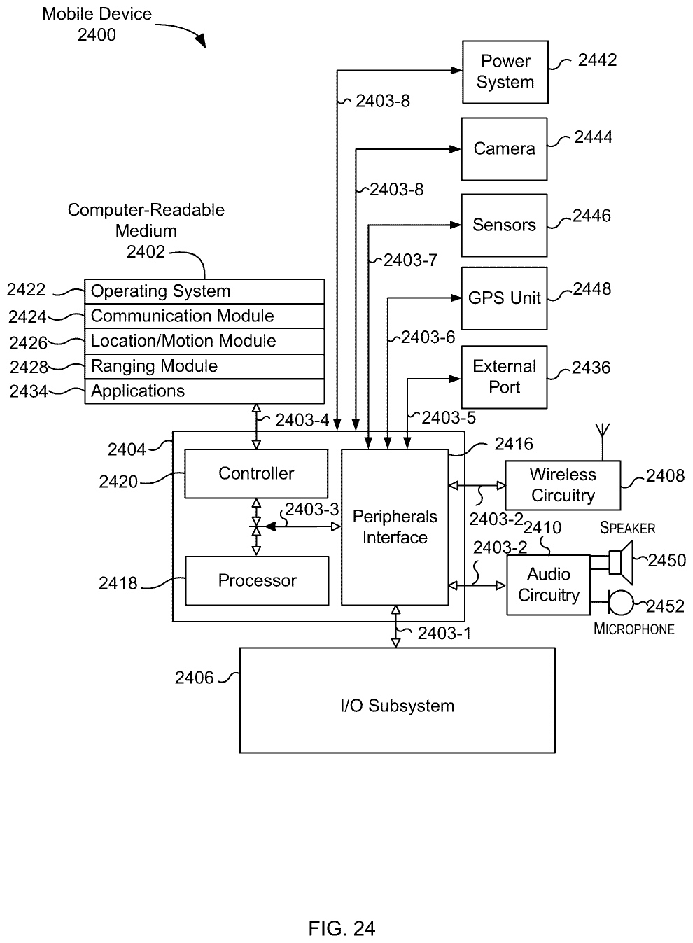

FIG. 24 is a block diagram of an example device 2400, which may be a mobile device. Device 2400 generally includes computer-readable medium 2402, a processing system 2404, an Input/Output (I/O) subsystem 2406, wireless circuitry 2408, and audio circuitry 2410 including speaker 2450 and microphone 2452. These components may be coupled by one or more communication buses or signal lines 2403. Device 2400 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 24 is only one example of an architecture for device 2400, and that device 2400 can have more or fewer components than shown, or a different configuration of components. The various components shown in FIG. 24 can be implemented in hardware, software, or a combination of both hardware and software, including one or more signal processing and/or application specific integrated circuits.

Wireless circuitry 2408 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 2408 can use various protocols, e.g., as described herein.

Wireless circuitry 2408 is coupled to processing system 2404 via peripherals interface 2416. Interface 2416 can include conventional components for establishing and maintaining communication between peripherals and processing system 2404. Voice and data information received by wireless circuitry 2408 (e.g., in speech recognition or voice command applications) is sent to one or more processors 2418 via peripherals interface 2416. One or more processors 2418 are configurable to process various data formats for one or more application programs 2434 stored on medium 2402.

Peripherals interface 2416 couple the input and output peripherals of the device to processor 2418 and computer-readable medium 2402. One or more processors 2418 communicate with computer-readable medium 2402 via a controller 2420. Computer-readable medium 2402 can be any device or medium that can store code and/or data for use by one or more processors 2418. Medium 2402 can include a memory hierarchy, including cache, main memory, and secondary memory.

Device 2400 also includes a power system 2442 for powering the various hardware components. Power system 2442 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management and distribution of power in mobile devices.

In some embodiments, device 2400 includes a camera 2444. In some embodiments, device 2400 includes sensors 2446. Sensors 2446 can include accelerometers, compasses, gyrometers, pressure sensors, audio sensors, light sensors, barometers, and the like. Sensors 2446 can be used to sense location aspects, such as auditory or light signatures of a location.

In some embodiments, device 2400 can include a GPS receiver, sometimes referred to as a GPS unit 2448. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other embodiments, device 2400 may be configured to identify GLONASS signals, or any other similar type of satellite navigational signal.

One or more processors 2418 run various software components stored in medium 2402 to perform various functions for device 2400. In some embodiments, the software components include an operating system 2422, a communication module (or set of instructions) 2424, a location module (or set of instructions) 2426, a triggering event module 2428, a predicted app manager module 2430, and other applications (or set of instructions) 2434, such as a car locator app and a navigation app.

Operating system 2422 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 2424 facilitates communication with other devices over one or more external ports 2436 or via wireless circuitry 2408 and includes various software components for handling data received from wireless circuitry 2408 and/or external port 2436. External port 2436 (e.g., USB, FireWire, Lightning connector, 60-pin connector, etc.) is adapted for coupling directly to other devices or indirectly over a network (e.g., the Internet, wireless LAN, etc.).

Location/motion module 2426 can assist in determining the current position (e.g., coordinates or other geographic location identifier) and motion of device 2400. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 2426 receives data from GPS unit 2448 and analyzes the signals to determine the current position of the mobile device. In some embodiments, location/motion module 2426 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 2408 and is passed to location/motion module 2426. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 2400 based on the position coordinates of the corresponding transmitters. Regardless of the specific location technology used, location/motion module 2426 receives information from which a location fix can be derived, interprets that information, and returns location information, such as geographic coordinates, latitude/longitude, or other location fix data.

Triggering event module 2428 can include various sub-modules or systems, e.g., as described herein with respect to FIG. 2A. Furthermore, predicted app manager module 2430 can include various sub-modules or systems, e.g., as described herein with respect to FIG. 3.

The one or more application programs 2434 on the mobile device can include any applications installed on the device 2400, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 2406 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 2406 can include a display and user input devices such as a keyboard, mouse, and/or track pad. In some embodiments, I/O subsystem 2406 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 2402) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 2400 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information, but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

1. A method performed by a processor of a first mobile device, comprising:
for each of a plurality of ranging sessions occurring during a time period:
transmitting a wireless ranging signal at a first time;
receiving a wireless response signal from a second mobile device at a second time;
determining a range value between the first mobile device and the second mobile device based on a difference between the first time and the second time, thereby determining a set of range values;
determining first odometry information from first measurements captured during the time period using a first sensor on the first mobile device, the first odometry information indicating a first motion of the first mobile device during the time period;
receiving, via a data channel between the first mobile device and the second mobile device, second odometry information determined from second sensor measurements captured during the time period using a second sensor on the second mobile device, the second odometry information indicating a second motion of the second mobile device during the time period;
solving an angle between a first reference frame for the first mobile device and a second reference frame for the second mobile device using the set of range values, the first odometry information, and the second odometry information; and
displaying, on a display of the first mobile device, directional information indicating a direction from a first current position of the first mobile device to a second current position of the second mobile device.

2. The method of claim 1, wherein the second sensor is an optical sensor and the second sensor measurements comprise odometry information.

3. The method of claim 1, wherein the second sensor is an accelerometer, and the second sensor measurements comprise acceleration information for the second mobile device.

4. The method of claim 1, wherein the solving the angle between the first reference frame for the first mobile device and the second reference frame for the second mobile device is based at least on the range value, the first odometry information and the second sensor measurements using a least squares equation.

5. The method of claim 1, wherein the first mobile device and the second mobile device are in motion.

6. The method of claim 1, wherein the solving the angle between the first reference frame for the first mobile device and the second reference frame for the second mobile device comprises calculating a vertical displacement, a horizontal displacement, and a heading offset between the first mobile device and the second mobile device.

7. The method of claim 1, wherein the first odometry information comprises visual-inertial odometry information.

8. The method of claim 1, wherein the data channel comprises a narrow band channel controlled by an ultrawideband processing chip.

9. The method of claim 1, further comprising:
determining if a relative position between the second mobile device does not change; and suppressing display of the directional information from the first mobile device to the second mobile device based on the angle.

10. The method of claim 1, wherein the directional information is an arrow.

11. The method of claim 1, further comprising:
determining a first uncertainty in the second current position of the second mobile device;
determining a first location of the first mobile device based on first GNSS signals obtained by the first mobile device;
receiving, via the data channel between the first mobile device and the second mobile device, a second location of the second mobile device based on second GNSS signals;
determining a second range value between the first location and the second location;
determining a second uncertainty in the second range value;
determining a position vector between the first mobile device and the second mobile device using the second current position, the first uncertainty, the second range value, and the second uncertainty; and
display the directional information based on the position vector.

12. The method of claim 1, further comprising:
storing a grid of reference points of a global reference frame;
determining, using measurements made by the first mobile device, a first location of the first mobile device within the global reference frame;
detecting a wireless signal transmitted from a second mobile device;
determining a relative position between the first mobile device and the second mobile device based on the wireless signal transmitted by the second mobile device during at least one of the plurality of ranging sessions;
receiving, from the second mobile device via the data channel, an offset value corresponding to a distance between the second mobile device and a first reference point of the reference points, wherein the offset value is measured by the second mobile device;
identifying a stored reference point of the grid of reference points corresponds to the first reference point based on the first location of the first mobile device, the relative position between the first mobile device and the second mobile device, and the offset value; and
determining a second location of the second mobile device based on the stored reference point and the offset value.

13. A first mobile device, comprising:
one or more processors; and
a memory coupled to the one or more processors, the memory storing instructions that cause the one or more processors to perform operations to:
for each of a plurality of ranging sessions occurring during a time period:
transmit a wireless ranging signal at a first time;
receive a wireless response signal from a second mobile device at a second time;
determine a range value between the first mobile device and the second mobile device based on a difference between the first time and the second time, thereby determining a set of range values;
determine first odometry information from first measurements captured during the time period using a first sensor on the first mobile device, the first odometry information indicating a first motion of the first mobile device during the time period;
receive, via a data channel between the first mobile device and the second mobile device, second odometry information determined from second sensor measurements captured during the time period using a second sensor on the second mobile device, the second odometry information indicating a second motion of the second mobile device during the time period;
solve an angle between a first reference frame for the first mobile device and a second reference frame for the second mobile device using the set of range values, the first odometry information, and the second odometry information; and
display, on a display of the first mobile device, directional information indicating a direction from a first current position of the first mobile device to a second current position of the second mobile device.

14. The first mobile device of claim 13, wherein the second sensor is an optical sensor and the second sensor measurements comprise odometry information.

15. The first mobile device of claim 13, wherein the second sensor is an accelerometer, and the second sensor measurements comprise acceleration information for the second mobile device.

16. The first mobile device of claim 13, wherein the solving the angle between the first reference frame for the first mobile device and the second reference frame for the second mobile device is based at least on the range value, the first odometry information and the second sensor measurements using a least squares equation.

17. A non-transitory, computer readable medium, the non-transitory computer readable medium storing instructions that when executed on one or more processors perform operations to:
for each of a plurality of ranging sessions occurring during a time period:
transmit a wireless ranging signal at a first time;
receive a wireless response signal from a second mobile device at a second time;
determine a range value between a first mobile device and the second mobile device based on a difference between the first time and the second time, thereby determining a set of range values;
determine first odometry information from first measurements captured during the time period using a first sensor on the first mobile device, the first odometry information indicating a first motion of the first mobile device during the time period;
receive, via a data channel between the first mobile device and the second mobile device, second odometry information determined from second sensor measurements captured during the time period using a second sensor on the second mobile device, the second odometry information indicating a second motion of the second mobile device during the time period;
solve an angle between a first reference frame for the first mobile device and a second reference frame for the second mobile device using the set of range values, the first odometry information, and the second odometry information; and
display, on a display of the first mobile device, directional information indicating a direction from a first current position of the first mobile device to a second current position of the second mobile device.

18. The non-transitory computer readable medium of claim 17, wherein the second sensor is an optical sensor and the second sensor measurements comprise odometry information.

19. The non-transitory computer readable medium of claim 17, wherein the second sensor is an accelerometer, and the second sensor measurements comprise acceleration information for the second mobile device.

20. The non-transitory computer readable medium of claim 19, wherein the solving the angle between the first reference frame for the first mobile device and the second reference frame for the second mobile device is based at least on the range value, the first odometry information and the second sensor measurements using a least squares equation.

21.-41. (canceled)
